(19) United States
(12) Patent Application Publication
(10) Pub. No.: US 2007/0078814 A1
(43) Pub. Date: Apr. 5, 2007

(54) Novel information retrieval systems and methods

(75) Inventors: John S. Flowers, Mission, KS (US); Michael Farmer, Kansas City, MO (US); Martin A. Quiroga, Kansas City, MO (US); Gordon H. Fischer, Kansas City, MO (US); John A. DeSanto, Kansas City, MO (US)

Correspondence Address: POLSINELLI SHALTON FLANIGAN SUELTHAUS PC, 700 W. 47TH STREET, SUITE 1000, KANSAS CITY, MO, 64112-1802, US

(73) Assignee: Kozoru, Inc., Overland Park, KS (US)

(21) Appl. No.: 11/243,386

(22) Filed: Oct. 4, 2005

(51) Int. Cl. G06F 17/30

(52) U.S. Cl. 707/2

(57) ABSTRACT

The present invention is directed to systems and methods for encoding and retrieving information from a variety of sources using novel search techniques. The systems and methods of the invention are capable of extracting all types of structural and relational information from a query or a source data allowing for the recognition of subtle differences in meaning. The capability of discerning subtle differences in meaning that are beyond the search systems and methods presently available, the invention described herein is capable of repeatedly providing accurate and meaningful responses to a diverse set of queries.

### CROSS-REFERENCES TO RELATED APPLICATIONS

This application claims benefit of priority to U.S. provisional application entitled “Novel Information Systems and Methods” filed Oct. 3, 2005 and not yet assigned a Ser. No., and U.S. application Ser. No. 11/178,513 filed Jul. 11, 2005, which is a continuation-in-part of U.S. application Ser. No. 11/117,186 filed Apr. 28, 2005, which is a continuation-in-part of U.S. application Ser. No. 11/096,118 filed Mar. 31, 2005. All of these patent applications are incorporated by reference herein.

### FIELD OF THE INVENTION

The present invention is directed to systems and methods for encoding and retrieving information from a variety of sources using novel search techniques. The systems and methods of the invention are capable of extracting all types of structural and relational information from a query or a source data allowing for the recognition of subtle differences in meaning. The capability of discerning subtle differences in meaning that are beyond the search systems and methods presently available, the invention described herein is capable of repeatedly providing accurate and meaningful responses to a diverse set of queries.

### BACKGROUND OF THE INVENTION

As technology progresses, considerable amounts of information are becoming digitized, so as to be accessible through databases, servers and other storage media, along networks, including the Internet. When a user seeks certain information, it is essential to provide the most relevant information in the shortest time. As a result, search engines have been developed, to provide users with such relevant information.

Search engines are programs that search documents for specified keywords, and return a list of the documents where the keywords were found. The search engines may find these documents on public networks, such as the World Wide Web (WWW), newsgroups, and the like.

Contemporary search engines operate by indexing keywords in documents. These documents include, for example, web pages, and other electronic documents. Keywords are words or groups of words that are used to identify data or data objects. Users typically enter words, phrases or the like, typically with Boolean connectors, as queries, on an interface, such as a Graphical User Interface (GUI), associated with a particular search engine. The search engine isolates certain words in the queries, and searches for occurrences of those keywords in its indexed set of documents. The search engine then returns one or more results to the GUI. These results typically include text containing the keyword(s) of the query, a hypertext link to a targeted web site, that if clicked by the user, will direct the browser associated with the user to the targeted web site.

Other contemporary search engines have to augment or replace keyword searching, by allowing a user to enter a query in natural language. Natural language, as used here and throughout this document (as indicated below), includes groups of words that humans use in their ordinary and customary course of communication, such as in normal everyday communication (verbal, written or typed) with other humans, and, for example, may involve writing groups of words in an order as though the writer was addressing another person (human). These systems that use natural language are either template-based systems or semantic based systems. These systems can operate together or independently of each other.

Template based systems employ a variety of question templates, each of which is responsible for handling a particular type of query. For example, templates may be instruction templates (How do I “QQ”?), price templates (How much does “RR” cost), direction templates (Where is “SS” located?), historical templates (When did “TT” occur), contemporary templates (What is the population of “UU”?, Who is the leader of “VV”?), and other templates, such as (What is the market cap of “WW”?, What is the stock price of “XX”?). These templates take the natural language entered and couple it with keywords, here for example, “QQ”-“XX” and may further add keywords, in order to produce a refined search for providing a response to the query.

Semantic based systems are similar to template based systems, and utilize knowledge that has been previously captured to improve on searches that would utilize keywords in the query. For example, a search using the keyword “cats” might be expanded by adding the word “feline” from the knowledge base that cats are felines. In another example, the keyword “veterinarians” and the phrase “animal doctor” may be synonymous in accordance with the knowledge base.

However, both the template and semantic based systems, although using some natural language, continue to conduct keyword-based searches. This is because they continue to extract keywords from the natural language queries entered, and search based on these keywords. While the searches conducted can be more refined than pure keyword based search engines, these systems do not utilize the complete natural language as it is captured (written, spoken, or typed) and in summary, perform merely refined keyword searches. The results of such searches are inaccurate and have little if any chance of returning a precise answer for the query.

Such template or semantic based systems required the establishment of human entered templates, or human established ontological structures and therefore are not fully computer automated. The result is that such systems are not scaleable to fully utilize all potential representations of natural language, to offer full understanding of all potential queries or subsequent answers that could be processed by such a system.

### SUMMARY OF THE INVENTION

The present invention provides novel search methods and systems generating responses that are more relevant to a user query and more informative than currently provided in the prior art. Moreover, the present invention is highly malleable, and may be deployed in a variety of environments where accurate and timely information to questions or problems is desired.

Accordingly, the present invention includes methods for providing at least a best query response to a user. These methods involve receiving a query from the user; processing the query by parsing the entire query wherein the word relationships of the entire query are used in ranking prospective query responses including identifying a best query response; and providing at least the best query response to the user. The query is preferably in Natural Language Format. In some aspects receiving the query includes collecting keystrokes from a keyboard input. In other aspects the at least the best query response includes at least one sentence; and a link to a source containing the at least one sentence. The at least one sentence may be a plurality of sentences that are taken in context from the source. Some embodiments of the present invention provide a user with feedback solicitation.

In other aspects providing at least the best query response to the user includes generating an analog signal, including at least the best query response, which is audible to the user. The analog signal may be transmitted via a telephonic device.

In other aspects receiving the query includes collecting a handwritten representation of the query and converting the handwritten representation to ASCII characters. In still other aspects receiving the query comprises collecting an audio input. The audio input may optionally be analog, in which case processing includes converting the audio input into a digital textual representation. Alternatively the audio input may be digital or analog. When the audio input is analog, the processing step may include converting the identified entire enquiry into a digital representation. Still other aspects have audio input from a telephonic device or network.

In some embodiments the audio input is a streamed signal and the processing includes identifying the entire query in the streamed signal and parsing the entire query without interrupting receiving of the streamed signal.

Optional methods also include displaying an object indicating the accuracy of the query response in relation to the query from the user. The object may be a graphic image or a text message. In some aspects of the invention, ranking prospective query responses includes weighting prospective query response rank by comparing each prospective query response to user personal information wherein the rank of each prospective query response is adjusted in relation to the percentage match of the prospective query response to the user information.

Additional optional methods include displaying a response indicating additional query responses are available for a fee and providing a process for payment of the fee wherein payment of the fee executes a process for identifying the additional query responses and providing the additional query responses to the user.

In several embodiments of the invention, processing the query includes relationally associating words of the query to form wordsets where each word of the query is allocated to at least one wordset. Typically, words are also associated with concepts that identify their usage within the query. Each word and its associated concept is given a concept identifier (CID). In turn, wordsets may be reduced to a series of linked CIDS. Each group of linked CIDs may be assigned a concept link identifier or CLID. Clides may then be linked, as described below, to form an abstract representation of the sentence including structural relationships between words in the sentence. This abstract representation is referred to as a statement.

The search accuracy of the present invention may be further enhanced by including weighted values to CIDs and/or CLIDS during the process based on the position of the CID or CLID in the sentence. For example, where the sentence is in the form of a question, the word value may increase as the position of the word approaches the end of the sentence. If the sentence is not a question, the word value may increase as the position of the word approaches the beginning of the sentence.

Some embodiments of the present invention include a determination of the context of the query, where processing the query may include identifying a best query response by determining a response context for each prospective query response and comparing the query context to the response context for each prospective query response. Context may be geographical, locational, political or cultural. In particular embodiments the context relates to an individual user.

Relevancy tags may also be included in a response of the present invention. The relevancy tag may identify an uninformative response. In certain aspects of these embodiments the method will also include prompting the user for additional query information when the relevancy tag of each prospective query response identifies the query response as uninformative. A relevancy explanation may also be included, for example a statement that the response is relevant or not relevant.

Responses may also be ranked based, for example on the origin of the response. E.g., a source ID for each prospective query response may be included and rating each prospective query response based on a predetermined value ranking of the corresponding source ID.

The invention also contemplates embodiments where the user receives at least the best query response through an instant messaging system. Typically the user is provided a response as a user-readable text message. Alternatively, the response may be provided as an audible analog speech message, or through a web browser.

The present invention also includes methods for providing at least a best query response to a user. These methods include receiving a query from the user; processing the query through one or more query agents and providing at least the best query response to the user. In such embodiments each query agent includes a processing object for parsing the entire query wherein the word relationships of the entire query are used in ranking prospective query responses including identifying a best query response; a transmitting object for transmitting the parsed entire query to at least one domain; and a receiving object for receiving at least the best query response from the at least one domain. Some aspects optionjally have domain(s) that include one or more data stores such as the world wide web, a local data store, a LAN data store, a WAN data store or the deep web.

Methods for providing a context-driven response to a user are also included in the present invention. These methods include receiving a query from the user; parsing the entire query using a relational parser to establish a set of query word relationships for each word in the query wherein the word relationships of the entire query are used in identifying prospective query responses; processing each identified prospective query response; comparing each set of response statement word relationships with the set of query word relationships; ranking identified prospective query responses based on degree of similarity between the associated set of response statement word relationships and the set of query word relationships, and identifying at least the best query response; and providing at least the best query response to the user. In these methods, processing each identified prospective query response results in one or more sentences being identified for each prospective query response, and each sentence being parsed using the relational parser to establish an associated set of response statement word relationships for each word in the statement.

Search systems for providing at least a best query response to a user are also included in the present invention. These systems include a first user interface for receiving an entire query from the user; a processing object for parsing the entire query wherein the word relationships of the entire query are used in ranking prospective query responses including identifying a best query response and a second user interface for presenting at least the best query response to the user. In some optional systems the first user interface is the same as the second user interface. In certain aspects the the first user interface is a web browser executed on a computer. In other aspects the first user interface is a telephonic transmitter and the second user interface is a telephonic receiver, and in others an electronic graphical tablet.

Some systems of the present invention also include one or more query agents, with a processing object that includes a communication object for transmitting the parsed entire query to at least one query agent and receiving at least the best query response from at least one query agent. In certain optional systems each query agent is independently associated with one or more data stores. Communications links in system embodiments may be wired or wireless and use any suitable communications protocol known in the art.

Other systems for providing at least a best query response to a user include a first user interface for receiving an entire query from the user; one or more parsing query agents, and a second user interface for presenting at least the best query response to the user. Parsing query agents in these systems include a processing object for parsing the entire query wherein the word relationships of the entire query are used in ranking prospective query responses including identifying a best query response; a transmitting object for transmitting the parsed entire query to at least one domain; and a receiving object for receiving at least the best query response from the at least one domain.

Still other systems for providing at least a best query response to a user include a first user interface for receiving an entire query from the user; one or more query agents and a second user interface for presenting at least the best query response to the user. In these systems the query agent include a processing object for parsing the entire query wherein the word relationships of the entire query are used in ranking prospective query responses including identifying a best query response; a transmitting object for transmitting the parsed entire query to at least one domain; and a receiving object for receiving at least the best query response from the at least one domain.

The present invention also includes methods for providing at least a best advertisement response to a user. These methods include receiving a query from the user; processing the query whereby a query statement is created by parsing the entire query, the query statement thereby encoding word relationships of the entire query; ranking a set of prospective advertisement responses, including identifying a best advertisement response, using the query statement; and providing at least the best advertisement response to the user. Some method embodiments also include charging an advertising customer for providing the advertisement response to the user, and may optionally also include creating a set of advertisement response statements for each prospective advertisement response. The amount charged to a customer may be determined by the size of the set of advertisement response statements associated with the provided advertisement response.

Methods for operating an information provision business are also included herein. Such methods include receiving a query from the user; processing the query by parsing the entire query wherein the word relationships of the entire query are used in ranking prospective query responses including identifying a best query response; providing at least the best query response to the user; comparing at least the best query response to a predetermined set of advertisement responses wherein at least a best advertisement response is identified; and providing at least the best advertisement response to the user. These methods may optionally include charging a customer for at least the best advertisement response.

In other embodiments providing at least the best advertisement response to the user includes creating a set of query response statements for at least the best query response; creating at least one set of advertisement response statements for at least one advertisement response selected from the predetermined set of prospective advertisement responses and comparing each advertisement response statement with each query response statement, where the advertisement response statement, having the highest percentage match with a query response statement from the set of query response statements for at least the best query response, is associated with the set of advertisement response statements generated from the best advertisement response.

Methods of efficiently storing information in an encoded database are also included in the present invention. These methods include retrieving a document; processing the document; constructing a data set of statements representing the document; and storing the data set in a database. Processing the document in these methods involves extracting one or more sentences from the document; parsing each sentence into one or more wordsets and linking all wordsets parsed from the sentence to form a statement where the linked wordsets are spatially related to each other in the statement according to the position in the sentence of the respective first word of each wordset. Each sentence is parsed into one or more wordsets such that each wordset includes a plurality of words; words within each wordset are contextually related and spatially orientated in the same order within the wordset as in the sentence; and all words in the sentence are a member of at least one wordset.

Still other embodiments of the present invention are methods for efficiently storing information in an encoded database. These methods include retrieving a document; processing the document; constructing a data set comprising concept statements representing the document; and storing the data set in a database. Processing the document involves extracting one or more sentences from the document parsing each sentence into one or more wordsets where each wordset includes a plurality of words, words within each wordset are contextually related and spatially orientated in the same order within the wordset as in the sentence, and all words in the sentence are a member of at least one wordset; linking all wordsets parsed from the sentence wherein the linked wordsets are spatially related to each other according to the position in the sentence of the respective first word of each wordset; assigning a concept identifier to each word of each wordset wherein the concept identifier identifies a relationship between the word and other words in the wordset; and determining a concept link identifier for each wordset wherein the concept link identifier uniquely identifies the spatial orientation and value of the concept identifier(s) of the wordset thereby forming a concept statement encoding the sentence, the concept statement comprising a series of linked concept link identifiers.

Other embodiments of the present invention are methods of structurally defining a sentence. These methods parsing the sentence into one or more wordsets such that each wordset includes a plurality of words; words within each wordset are contextually related and spatially orientated in the same order within the wordset as in the sentence; and all words in the sentence are a member of at least one wordset. The methods also include linking all wordsets parsed from the sentence wherein the linked wordsets are spatially related to each other according to the position in the sentence of the respective first word of each wordset; assigning a concept identifier to each word of each wordset wherein the concept identifier identifies a relationship between the word and other words in the wordset; and determining a concept link identifier for each wordset wherein the concept link identifier uniquely identifies the spatial orientation and value of the concept identifier(s) of the wordset thereby forming a concept statement encoding the sentence, the concept statement comprising a series of linked concept link identifiers.

### BRIEF DESCRIPTION OF THE DRAWINGS

FIG. 1A-C are depictions of different embodiments of the present invention focusing on the diversity of user-interfaces suitable for use with the invention. FIG. 1A depicts the invention including an isolated workstation or consisting of a single computer. FIG. 1B depicts use of the invention in a LAN environment. FIG. 1C depicts the use of the invention through a variety of interfaces that can include either wired or wireless connections, and my use wide area networks (WAN) such as the World Wide Web (WWW) including the Deep Web.

FIG. 2 depicts a distributed embodiment of the present invention where source data are taken from, for example the WWW, are parsed according to content and accordingly stored in separate structured data stores.

FIG. 3 is a variant of the distributed embodiment illustrated in FIG. 2, with the user querying a specific query agent for a particular category of information. Each query agent has a separate structured data store. FIG. 3 also depicts the optional embodiment of independent query agents cross-communicating to identify responses to queries that span more than one category of information.

FIG. 4 depicts an additional distributive environment where multiple servers provide search capabilities to a plurality of users.

FIG. 5 depicts a distributive environment illustrating that individual users may serve as clients, servers or both in the information system of the present invention. As illustrated in

FIG. 5, the types of devices that can communicate through the present invention is diverse.

FIG. 6 is a diagram illustrating the manner in which a data parser element of the present invention populates the structured data. FIG. 6A provides a functional overview of the position of the data parser in the present invention. FIG. 6B illustrates the steps in generating the data to be stored in structured data.

FIG. 7 is a diagram illustrating the manner in which a query agent element of the present invention generates a response from a query. FIG. 7A provides a functional overview of the position of the query agent in the present invention. FIG. 7B illustrates the steps in generating a response from a query utilizing the data stored in structured data.

FIG. 8 is an abstract illustration of the document data structure. Only the document ID and the origin of the source data are essential elements in the document structure. FIG. 8 depicts several additional elements that may be optionally included.

FIG. 9 is an exemplary device embodiment of the present invention.

FIG. 10 is an exemplary output from an instant messaging embodiment of the present invention. FIG. 10A is a depiction of a user list of available users in the network. FIG. 10B is a depiction of exemplary interaction between one user and the present invention.

FIG. 11 illustrates an optional embodiment of FIG. 7A that utilizes alternative information, such as relational associations, that may enhance the relevancy of responses generated for a given enquiry.

FIG. 12 illustrates an optional embodiment of FIG. 7A that screens the query and/or potential responses for information that is then used to identify one or more advertisements for good or services that are relevant relevant to the query or response. In this manner advertisements are targeted to consumers based on their interests.

### DETAILED DESCRIPTION

I. Introduction

The present invention provides novel systems, devices, and methods for encoding and storing information in a manner that enhances retrieval of relevant information, especially from large and/or dispersed data sources. This is accomplished by encoding sentences contained within, or associated with, files in the data source in a manner that identifies structural characteristics of each word in the sentence, such as the relationship between words in the sentence. These encoded sentences are stored in a structured database and the information they relate to retrieved by comparing the stored encoded sentences with a statement that is generated by encoding a query in the same manner as the encoded sentences stored in the structured database. A unique aspect of the present invention is that every word of the query is evaluated in performing a search. Another unique aspect of the invention is that structural relationships found within a sentence and encoded by the present invention may relate to words that are distant from one another in the sentence structure.

The novel features noted above distinguish the present invention from other attempts to catalogue and/or search informational databases. In some cases these attempts are based on key word identification, and variants of key word search where multiple key words are sought, including variants of the approach evaluating proximity of the key words in the data being searched. Other attempts utilize templates that attempt to re-create certain structured query formats. By using all of the structural information available in both the stored data and the statement query, the present invention is able to identify subtle variations in meaning and context that are lost in current search methods available in the art. By evaluating these subtle variations in meaning and context, the present invention is capable of identifying information in the data source that is more relevant to the query seeking the information than are alternatives currently available in the art.

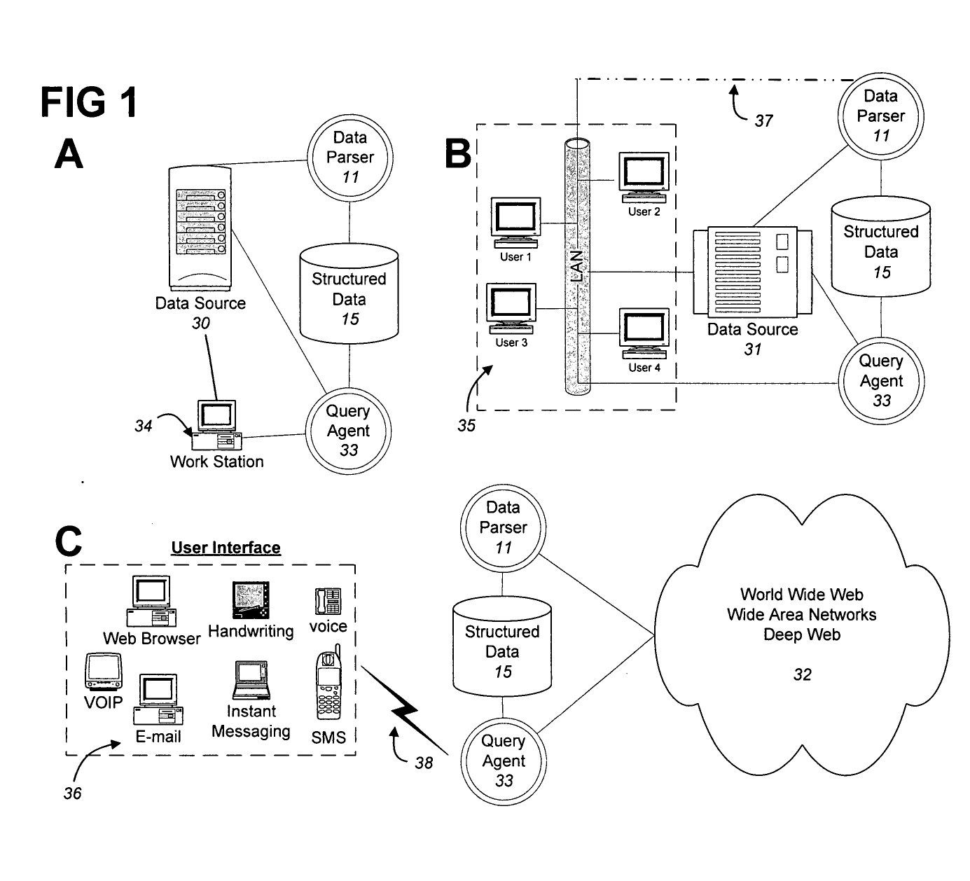

The present invention may be implemented through several embodiments. Referring to FIG. 1, FIG. 1A is a simple stand-alone implementation of the present invention. As depicted in FIG. 1A, a computer workstation 34 is operably linked to query agent 33. Query agent 33 is in turn operably linked to structured data 15 and a data source 30. A data parser 11 is also operably linked to structured data 15 and data source 30. One of skill in the art will recognize that all of the components illustrated in FIG. 1A could be housed in a single unit, such as a personal computer, including a portable hand-held computer.

The claimed invention is performed by first populating structured data 15 with encoded information pertaining to files stored in data source 30. This functionality is performed by data parser 11. Once structured data 15 is populated, the encoded information it contains may be used as a rapid index for identifying information in data source 30. Information in data source 30 is accessed through workstation 34, or another suitable interface to query agent 33. Workstation 34 accepts a query from a user. The query is passed to query agent 33, which parses the query and encodes the query using the same encoding method used by data parser 11. Query agent 33 then compares the encoded query to encoded information placed in structured data 15 by data parser 11. When query agent 33 identifies a match between the encoded query and the encoded sentences stored in structured data 15, query agent 33 returns stored information in structured data 15 identifying the file in data source 30 that gave rise to the stored encoded information. Query agent 33 may also optionally return the file itself from data source 30, or the user may retrieve the file from data source 30 through workstation using returned information from structured data 15.

FIG. 1B illustrates an extension of the implementation of the invention depicted in FIG. 1A. In FIG. 1B, the claimed invention is implemented over a local area network (“LAN”). Workstations in FIG. 1B are labeled “user 1” through “user 4.” All other labeled components in FIG. 1B operate as described for FIG. 1A, above. FIG. 1B also illustrates an optional communication connection 37 between data parser 11 and the LAN. Connection 37 allows each of user 1-4 of the LAN to act as an alternative data source to data source 31. In implementing this option, the location of files in the data source network (all data sources represented in structured data 15) must be stored and associated with encoded information of each file. This is most easily implemented by including such information in structured data 15.

FIG. 1C abstracts the data source another level by including wide area networks (WAN) including the worldwide web (“WWW”) and data sources referred to generally as the “Deep Web”, or “Invisible Web”. The Deep Web or Invisible Web refers to all data sources that are operably connected to the WWW, but are not indexed by WWW search engines. Thus the Deep Web or Invisible Web includes web pages that are not linked to other web pages, sites blocked by a password (both “free” sites and pay sites), proprietary web pages, ad hoc databases including web-accessible information that is stored on a web server or networked computer, and web accessible information with dynamic IP addresses.

FIG. 1C also illustrates that the user interface to the present invention may be supplied in a variety of forms including, but not limited to, web browsers executed on personal computers, simple messaging systems, electronic mail, voice-over-internet protocol, instant messaging, voice recognition-to-text conversion systems, and the like. FIG. 1C also illustrates that analog or digital input capable of digital or analog conversion, such as voice and handwriting is also contemplated as suitable input or output to the present invention. The invention contemplates optional embodiments that include storage of voice recordings or handwriting input for inclusion in responses to appropriate queries.

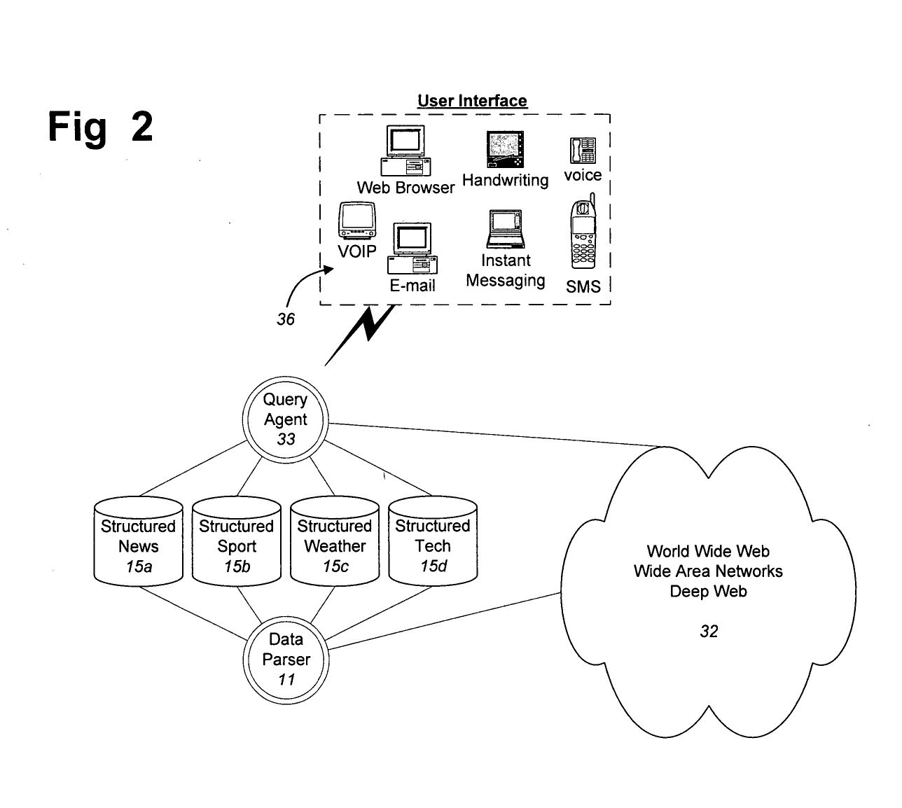

Moreover, operable links of the present invention may include any suitable means for transmitting digital information between components of the present invention. Examples include, electrically conductive materials and electromagnetic wave transmitting and/or receiving means, i.e., FIG. 2C illustrates communication link 38, which represents a digital wireless linkage, but could be substituted with any functional digital transmission linkage.

In addition to optionally including multiple data sources, certain optional embodiments of the present invention include a plurality of structured data 15 components. Such divisions of structured data 15 may be for practical purposes, such as providing flexible expandable storage space. Divisions of structured data 15 may also be implemented to conveniently organize related data, with the added benefit of speeding searches by limiting the size of the structured data 15 to be searched. FIG. 2 illustrates this latter implementation of the claimed invention.

In FIG. 2, structured data 15 is divided into a plurality of sub stores, 15a-d. By way of example, these sub stores contain information relating to news, sport, weather and tech, respectively. Sub stores 15a-d are populated by a common data parser 11, and searched by a common query agent 33. Data parser 11 determines which sub store(s) encoded information from each file will be preserved based, for example, on the content of the file or the source of the file. Similarly, query agent 33 may determine which sub store(s) to search, for example, based on the context of the query, or based on user preference. This optional embodiment may aid in focusing queries to appropriate data stores, enhancing responsiveness of the invention and, in the case of very large data stores, possible also enhancing the quality of the response, i.e., increased relevancy of the response to the query.

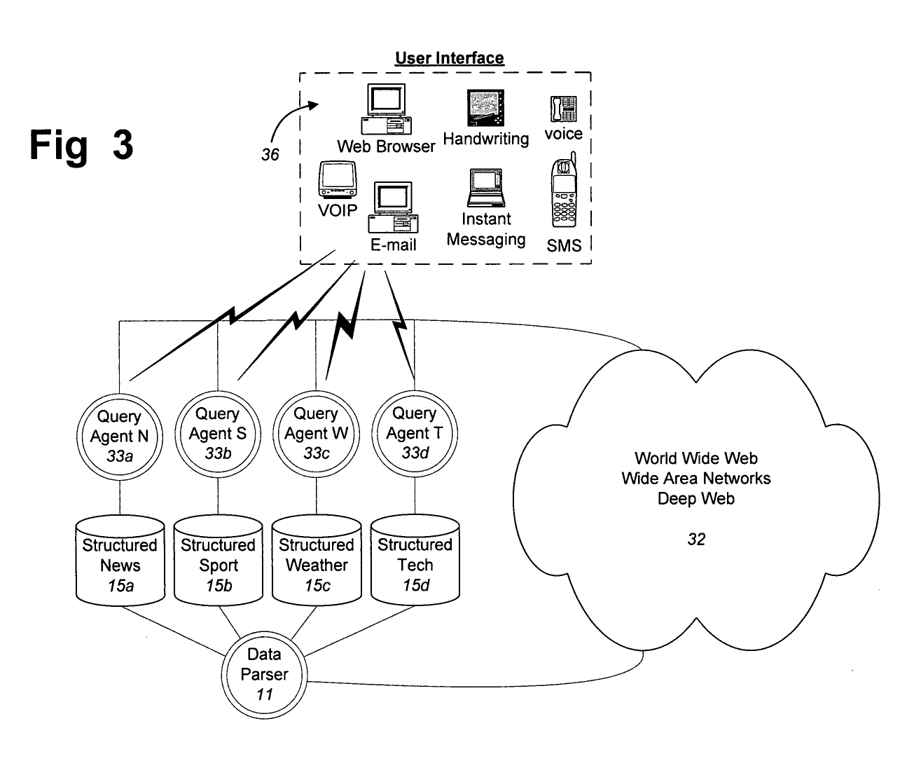

FIG. 3 illustrates an optional embodiment that is a variant to that in FIG. 2. In the FIG. 3 embodiment, a plurality of specialized query agents, 33a-d, is provided. Each specialized query agent 33a-d is associated with a dedicated structured data, 15a-d respectively, that contains information on a specific topic or category of information. In this embodiment, the user may choose which query agent(s) best address the category of information to be searched. It is important to note that query agents may optionally intercommunicate, for example when a query is identified that relates to two or more categories of information.

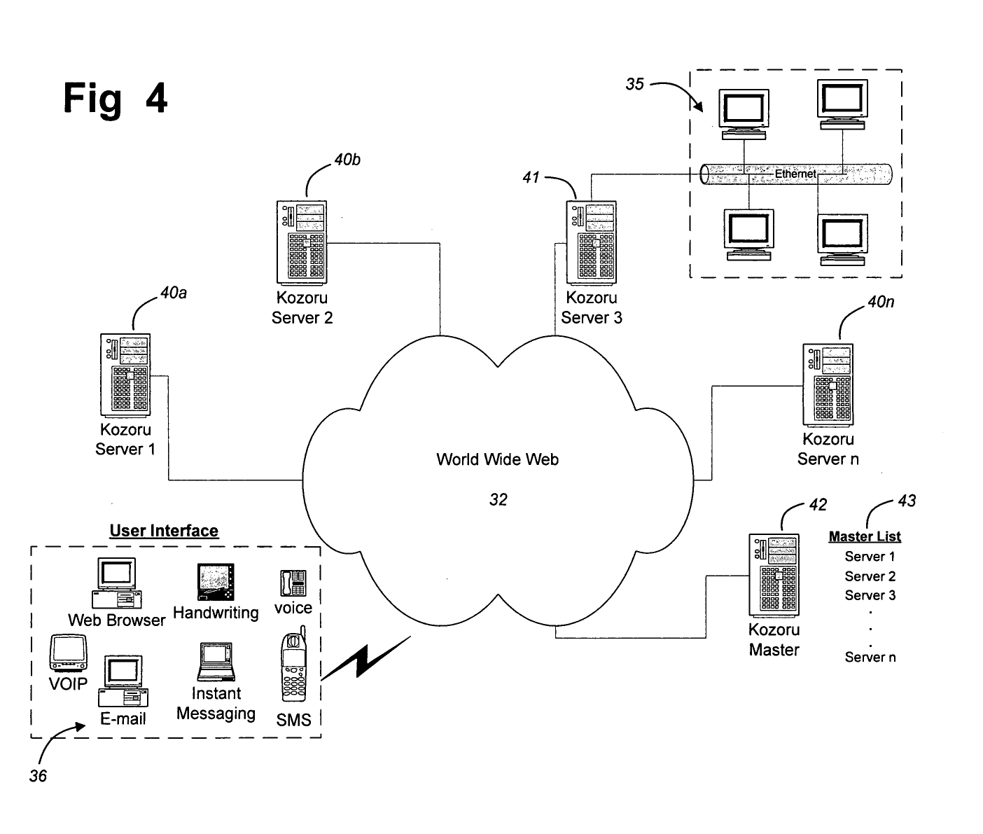

FIG. 4 illustrates that the present invention may be utilized in a distributive format, for example over a WAN, such as the WWW. In the distributive model illustrated in FIG. 4, a master server 42 retains a master list of servers 43. A user may interact with master server 42 to gain access to the information on the master list 43, or to be directed by master server 42 to the most appropriate server 40a-n. In alternative optional embodiments the master server list may maintain information regarding traffic on server 40a-n, information stored on server 40a-n and the like. This information may then be used to direct the query to the most appropriate server 40a-n. The response to the query may be sent directly from the appropriate server 40a-n to the user issuing the query via the WWW 32, or may be passed back to the user issuing the query via master server 42, or may be passed to multiple users using either approach.

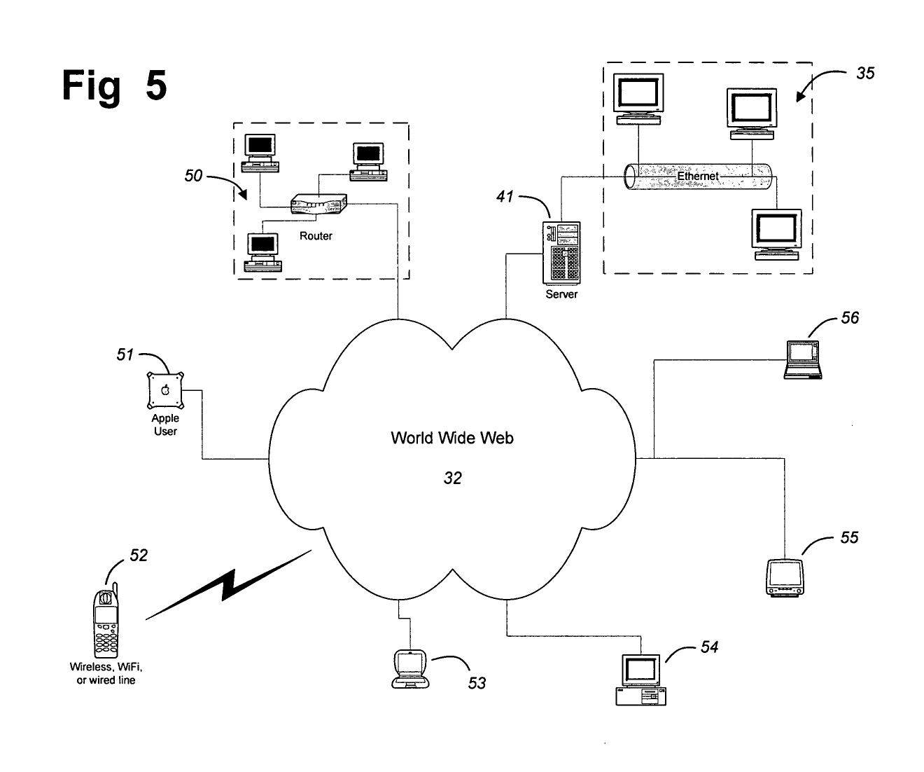

FIG. 5 illustrates that one or more users on the network may act as both a client and a server: I.e., each such user as both a query agent, a data parser and a structured data store. In this manner each such user contributes information to other network users as well as utilizes other users for responses in a manner similar to the popular bittorrent model. Local area networks 50 and 35 illustrate that distributive embodiments of the present invention are not limited to users connected directly to the WAN 32. Users connected to the WAN 32 via routers or servers (e.g., server 41) represent “Deep Web” contributors that may also contribute either directly to the network or may contribute via a common server (e.g., server 41).

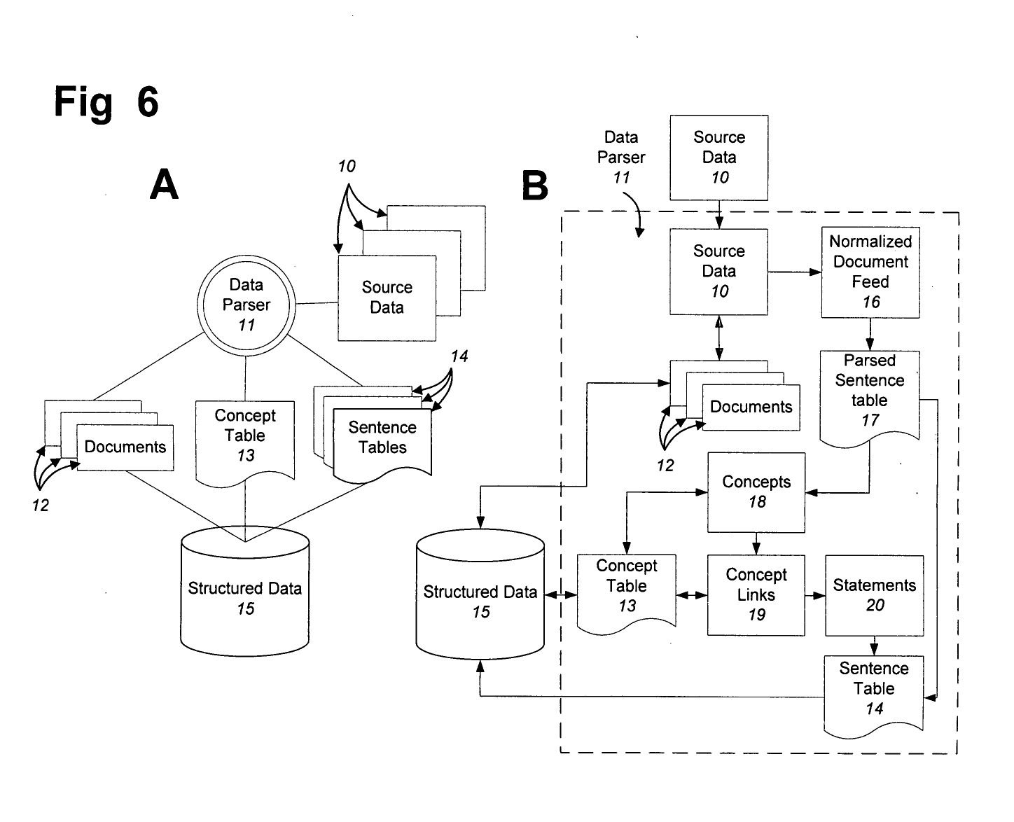

FIG. 6 illustrates the functional aspects of data parser 11. FIG. 6A is an overview depicting how data parser 11 interacts with other elements of the invention. Briefly, data parser 11 generates documents 12, concept table 13 and sentence table 14 from source data 10. Documents 12, concept table 13 and sentence table 14 are then stored in structured data 15. FIG. 6B illustrates in more detail how data parser 11 performs these functions. Data parser 11 first generates document 12 and normalized document feed 16 from source data 10. Document 12 contains information regarding source data 10 and a unique document id 30 (see description below). The normalized document feed 16 is the source data stripped of control characters and other information that is not pertinent to the parsing functions that follow. Conversion of source data 10 to normalized document feed 16 is discussed in greater detail below.

The normalized document feed is parsed into one or more sentences represented by the data abstraction parsed sentence table 17. The sentences identified as parsed sentence table 17 may be utilized for two purposes: First, the order of the sentences may be maintained and the sentences saved. Saving the sentences is a feature of the invention that allows rapid meaningful responses 61, because it is these sentences taken from source data 10 that serve as responses 61. Second, the sentences are further parsed to identify concepts 18, and concept links 19, both of which are preserved in structured data 15, e.g., by storage in a concept table. This process is discussed in detail below. Concept links 19 are in turn used to form statements 20. Statements 20 are associated with the sentences from which they where derived and stored in structured data 15, e.g., as sentence table 14.

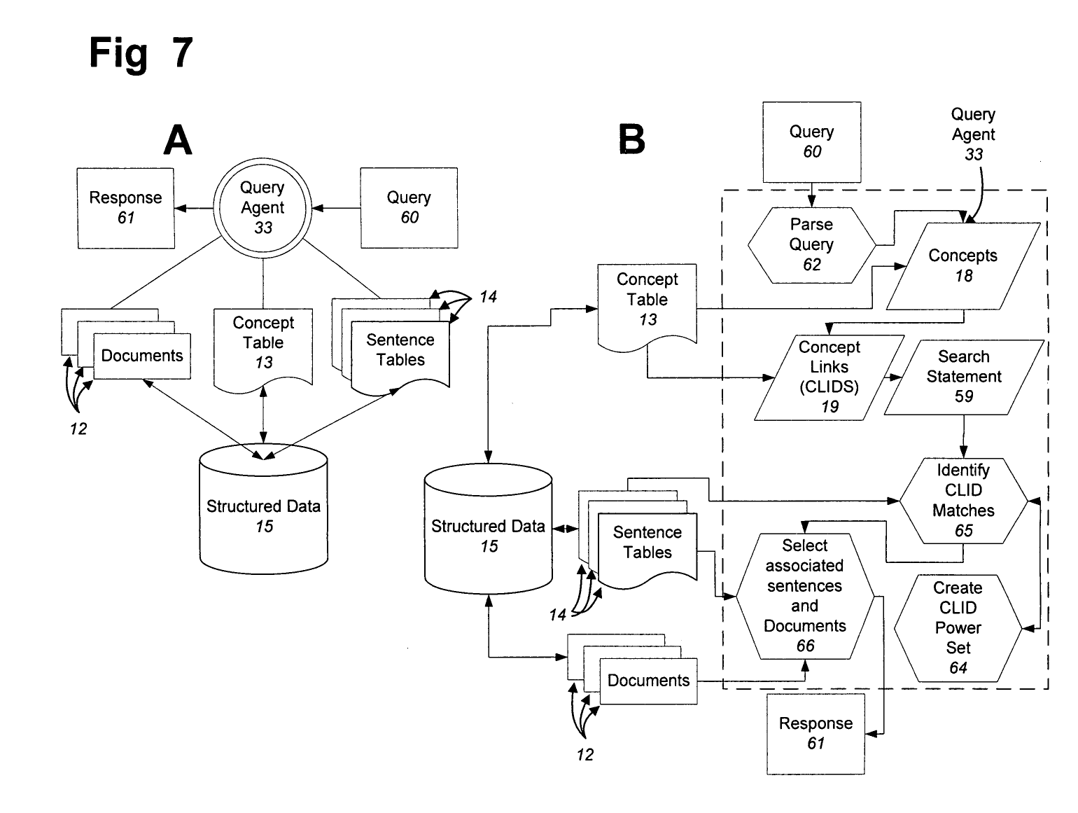

FIG. 7 illustrates the functional aspects of query agent 33. FIG. 7A is an overview depicting how query agent 33 interacts with other elements of the invention. Briefly, query agent 33 utilizes the information in documents 12, concept table 13 and sentence table 14 stored in structured data 15 to identify a response 61 to a query 60. FIG. 7B illustrates in more detail how query agent 33 performs these functions. Query agent 33 my first optionally parse query 60 to generate parse query 62. This optional parse may remove extraneous information not identifiable or may parse a complex query 60 into two or more sentences to be processed individually. Having identified a sentence, query agent 33 then generates concepts 18 for each word in the sentence (which may optionally include punctuation). Concepts 18 are generated by comparing each word and its usage in query 60 to the concepts in concept table 13 stored in structured data 15. Concepts are joined to generate concept links 19, and concept links joined to form search statement 59. This process is discussed in greater detail, below.

The search statement 59 is then compared to statements 20 stored in structured data 15 as part of, e.g., sentence tables 14. Briefly, the statements 20 having the most CLID matches or otherwise most closely matching the search statement 59 are identified. These may be optionally ranked using CLID powersets 64, as discussed in greater detail, below. The identified statements 20 are then used to identify their associated sentences and documents 12 at step 66. This is accomplished by using documents 12 (e.g., document id 30) and sentence table(s) 14. From the sentences and documents 12 so identified, a response 61 is generated and returned.

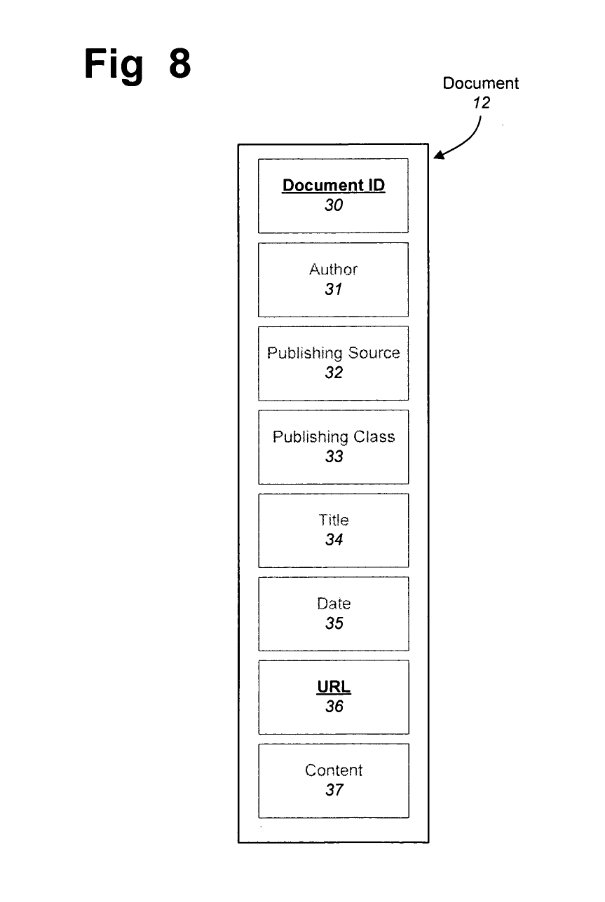

FIG. 8 is a diagrammatic representation of the data structure document 12. As discussed below, this data structure may contain any number of information fields for storing particulars about source data 10. Only two fields are required in document 12: document id 30, which uniquely identifies source data 10, and URL 36, which identifies the origin of source data 10.

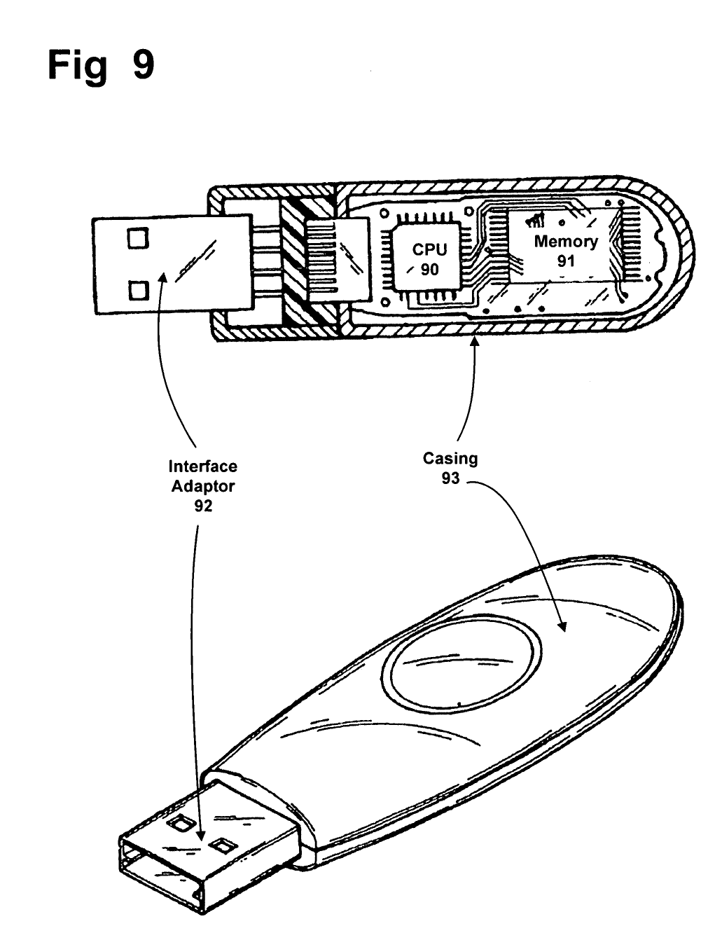

FIG. 9 is a diagrammatic representation of a device embodiment of the present invention. The device has a casing 90 and an interface adaptor 92, in addition to a CPU 90 and memory 91 in the form of a USB “key” device well known in the art. At least a portion of memory 91 is read/write capable, and may optionally contain executable code for performing the functions of the present invention as described herein below. Those of ordinary skill in the art that numerous device embodiments of the present invention may be utilized, for example, personal computers, portable computers, WiFi devices, card devices and the like.

A particularly preferable device embodiment of the present invention is a portable handheld device that has an interactive user interface and optionally has an internal storage means for retaining a database of source data and/or has wired/wireless capability that allows the device to access data from one or more networks. Other optional aspects include a graphics pad for handwritten input and voice recognition hardware and/or software.

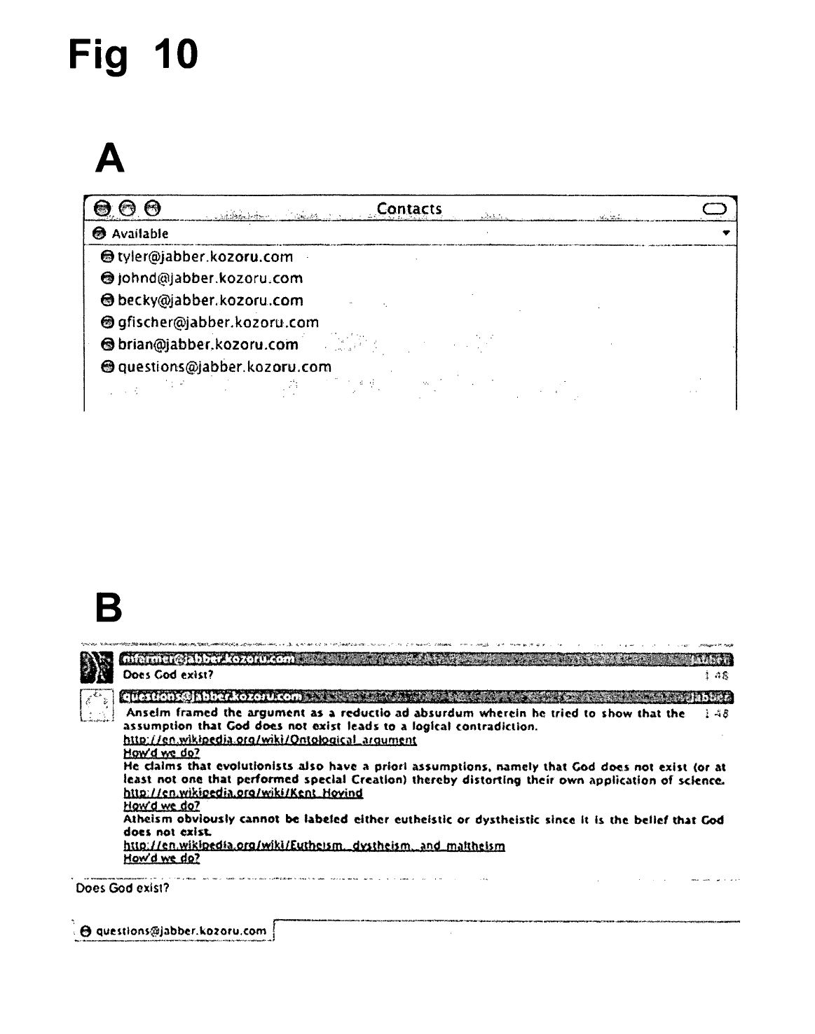

FIG. 10 is an illustration of displays associated with instant messaging embodiments of the present invention. FIG. 10A is a list of users in an exemplary instant messaging network. It should be noted that one of the “users” in the network depicted in FIG. 10A is “questions@kozoru.com.” This “user” represents the present invention, and may function in the network in one of a plurality of modes. For example, it may simply serve as a passive interface that may be queried by any other user in the network. In an alternative mode, the present invention may monitor interaction between other users in the network. When the present invention detects a query from or between users of the network, the invention processes the query, as described below, and returns a response. Thus in a given instant messaging session, the present invention behaves like an additional user, preferably retuning responses in a manner that is identical to other users participating in the session. This type of interaction is depicted in FIG. 10B.

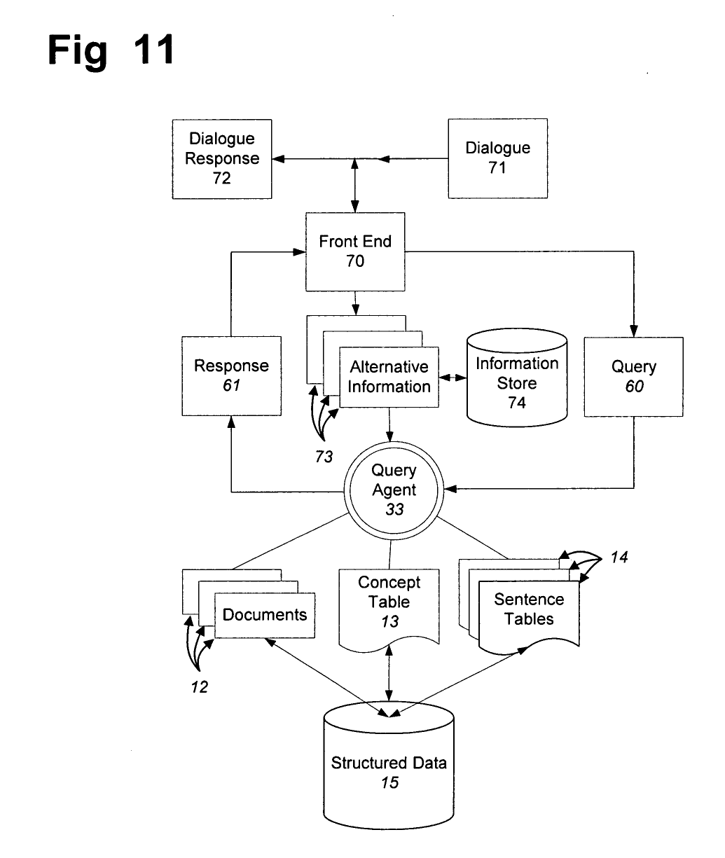

In certain embodiments, the present invention uses relational information to further enhance the accuracy and relevance or responses generated to a query. FIG. 11 depicts one such embodiment, where the present invention optionally monitors and participates in a dialogue between different users. This dialogue may be in the form of an instant messaging network, as described above.

The interface to the invention is depicted in FIG. 11 as front end 70. As presented, front end 70 serves as both an input device for receiving information from the user, and as a display device for presenting the response 61 generated by the present invention. In addition to accepting a query 60, front end 70 may also collect alternative information 73 from one or more users. Alternative information 73 may be solicited and/or received directly from a user of the invention, or it may be discerned from other input, including query 60, supplied by users. Alternative information may also be discerned from the response(s) 61 generated by query agent 33 to query 60. For purposes of the instant invention, alternative information may be user-specific information such as age, education level, job description, etc., may be groups specific, e.g., scientists, lawyers, computer programmers, or may alternatively be geographical, ethnic, etc.

Regardless of source, the alternative information 73 is stored in an information store 74, which may be common storage used by the present invention for other data storage, and accessed to enhance the quality of response 61 provided to a user supplying a query 60. Methods utilizing alternative information will be obvious to one of ordinary skill in the art, for example, key words may be taken from the alternative information and used to filter possible response(s) 61 before returning them to the user. In other embodiments the alternative information 73 may be used to generate a search statement 59, which in turn is used to screen potential response(s) 61 prior to returning response 61 to the user. Other elements of FIG. 11 relating to the function of query agent 33 perform as previously described for FIG. 7A herein.

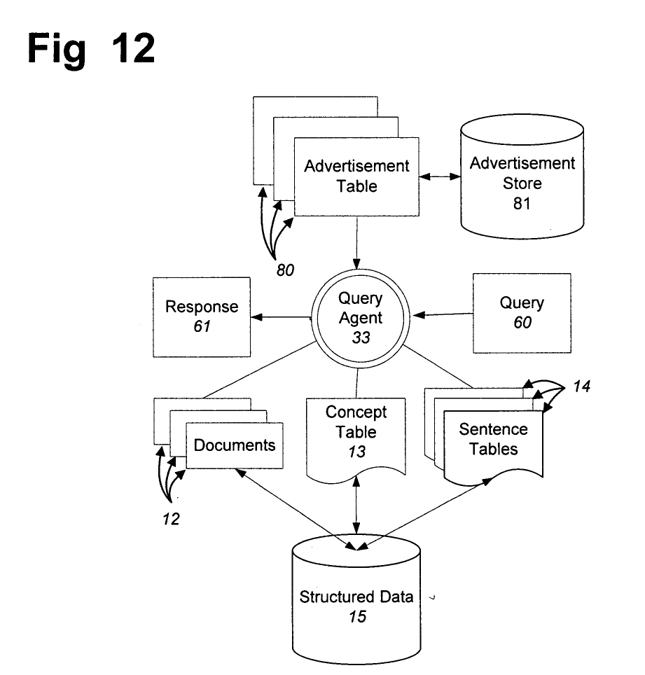

FIG. 12 illustrates an embodiment of the present invention that utilizes information in the response 61 generated to a query 60 to identify advertisements that the user may find interesting or appealing. In this embodiment the query agent 33 identifies one or more best possible responses 61. These one or more best possible responses 61 may then be compared to advertisements in advertisement table 80 stored in advertisement store 81. Comparison may be via keyword, or statement 20/search statement 59 comparison as discussed below. E.g., a statement 20 associated with a possible best response 61 could be used as a search statement to screen statements associated, for example, with sentences, phrases or metatag information relating to or taken from a stored advertisement. The nearest match (the match with the highest degree, as discussed below) would then identify an advertisement that relates to the response 61, may be of interest to the user and included in returned response 61.

II. Source Data

Raw data suitable for use with the present invention may be any form of digitized data, preferably either in a text format or associated with a textual identifier such as a metatag. By way of example raw data may be digitized text such as manuscripts, web pages, word processor files and the like. Alternatively, raw data may be graphics files, audio files, streaming audio and video data including television signals, executable applets, data files or attachments such as software files, or other data and files known in the art. Members of this latter group are preferably associated with a metatag that describes attributes of the file such as functionality, content, date of creation, and the like, preferably in digital text format. Metatags may take the form of a document as described herein and depicted in FIG. 8. Moreover, the present invention also contemplates pay for/per use database sources, both on local and wide area networks such as the World Wide Web. Ideally the format and structure of the data is known, which may improve the speed and accuracy of the interpretation of the data. However the structure of the data may be deduced using any method known to those of skill in the art, such as comparison of an unknown data file with templates constructed from known data file formats.

Raw data suitable for use with the present invention may be located on a single source, or be stored on multiple diverse sources. By way of example, data sources may be of known or unknown format stored in proprietary databases that are only accessible to users on a single machine or closed network, as depicted in FIGS. 1A and B. Alternatively, source data suitable for use with the present invention may be found on the World Wide Web (e.g., FIG. 1C), Wide area networks, the Deep Web, through peer-to-peer networks (e.g., FIG. 5), distributed servers (e.g., FIG. 4), local hard drives or other memory devices (both internal and portable), or any combination of the above. One of skill in the art will readily recognize there are a multitude of data storage combinations and data formats suitable for use with the present invention, each of which is contemplated as part of the present invention.

The storage media for source data may be of any type including written, analog, paper, etc., with the proviso that information data, such as metatags or textual components, be in a storage format capable of conversion to a format suitable for use with the present invention, preferably suitable for conversion to digital format, most preferably digitized textual format such as ASCII format. Storage media suitable for use with the present invention may be any known storage media for data, digital media and the like, and may include Redundant Array of Independent Disks (RAIDs), local hard disc(s), and sources for storing magnetic, electrical, optical signals and the like. Note that the source data does not need to be convertible to a format capable of being processed by the present invention. All that is necessary is that the informational data associated with the source data allow a user of the present invention to locate the respective source data.

II. Data Parser

A. General Operation

The data parser 11 of the present invention encodes language in a manner serving a number of functions including:
1. Encoding sentences associated with raw data in a manner that allows raw data relevant to a query 60 to be identified and presented as a response 61, and
2. Encoding and storing structural relationships between words of sentences in a manner that allows the system to identify alternative use of words in a developing language.

As used herein, the term “structural relationship” includes any relationship between sentence components that contributes meaning to the sentence. This includes syntactic and semantic relationships as well as simple word order. An exemplary structural relationship that isn't syntactic or semantic may be found in the sentence, “They got married and had a baby.” The structure of the sentence conveys “they got married” first, but this is not a semantic property of the sentence. The structural relationship between the clauses before and after “and”—i.e. the pragmatic implication that one happened before the other contributes to our understanding of the sentence. Another example of a structural relationship occurs with pronouns. Consider the sentence “John threw the dog a bone and he ate it.” Relationships between {dog, he} and {bone, it} are structural but not grammatical, and are key to a proper representation of the sentence.

Turning to FIGS. 1A-C, the data parser 11 is depicted diagrammatically in relation to other major components of the present invention. As depicted in FIGS. 1A-C, data parser 11 communicates with a data source 30, which is the source of the raw data discussed above, and structured data 15, which is the data storage for information produced by the data parser as described herein.

FIG. 6 provides a more detailed representation of how data parser 11 works. FIG. 6A depicts data parser 11 as generally accepting raw data in the form of source data 10. Source data 10 may be any type of digitized data, but preferably includes textual information. Data parser 11 processes the source data 10, producing at least one document 12 and one sentence table 14 per source data 10. The document(s) 12 and sentence table(s) 14 so produced are stored in structured data 15. The data parser also produces and maintains concept table 13. Concept table 13 is a data structure containing information on all words, and the structural relationship of each word in concept table 13 with other words found in the same sentence. The sentences containing the words that are codified in concept table 13 are taken from source data 10.

FIG. 6B provides a detailed depiction of how data parser 11 forms document 12, sentence table 14, and concept table 13. Briefly, source data 10 is first compared to documents 12 stored in structured data 15 to identify possible duplicate document entry into structured data 15. As discussed in detail below, and depicted diagrammatically in FIG. 8, each document 12 contains information related to the previous source data 10 processed by data parser 11. Any suitable data field of documents 12 may be used to make the comparison provided the data field uniquely identifies the source data 10. Different data fields may be used to identify different source data 10. If comparison of source data 10 to documents 12 identifies a duplicate entry, data parser 11 may respond by discarding the source data 10, or may discard the current entry represented by the associated document 12 (remove document 12 and the associated sentence table 14 from structured data 15, described below). Which of these two options data parser 11 performs may be conditional, for example, based on the duration of time that has elapsed since recordation of the current entry represented by the associated document 12.

Assuming data parser 11 discards the current entry represented by the associated document 12, the data parser 11 then creates a new document 12 from the source data 10 and stores this document 12 in structured data 15. The source data 10 is then transformed to a normalized document feed 16. A normalized document feed 16 is simply source data that has been converted into a format recognized by data parser 11, for example, into ASCII text or XML. The only limitation on the format chosen is that it be compatible with identification of sentences from the source data 10, as described herein, by data parser 11.

The requirement that the chosen format allow sentence identification is necessary because the data parser 11 uses the normalized document feed to create parsed sentence table 17. Parsed sentence table 17 is simply an abstract representation of the internal operation of the parser, and as such should not be construed as a limitation to the invention. Minimally, the parsed sentence table contains a representation of every sentence found in the normalized document feed 16. Parsed sentence table 17 may optionally include an indicator of sentence order within normalized document feed 16, preferably in the form of sentence order within an identified data structure. Parsed sentence table 17 may also include a document ID that associates the parsed sentence table 17 with associated document 12. This latter option is particularly useful in multitasking systems where multiple document feeds may be processed in parallel.

Parsed sentence table 17 is used by data parser 11 to identify concepts 18, and in the construction of sentence table 14. A concept 18 has two components: a word, and the concept type assigned to the word where the concept type may be a noun, pronoun, verb, adverb or adjective. Each word of each sentence in the parsed sentence table is used to form a concept 18. Data parser 11 compares each concept 18 identified from parsed sentence table 17 to concepts stored in structured data 15, represented by concept table 13. Concept table 13 includes all concepts 18 identified from processing previous normal document feeds 16, where each concept 18 of concept table 13 is associated with a unique concept ID or “CID.” If data parser 11 identifies a previous instance of a concept 18 in concept table 13, then concept 18 is assigned the CID for the concept stored in the concept table. If data parser 11 does not identify a previous instance of a concept 18 in concept table 13, then concept 18 is assigned a unique CID and the unique CID and associated concept 18 is stored added to concept table 13.

In addition to creating a concept 18 from each word of every sentence of parsed sentence table 17, data parser 11 also creates wordsets from the same sentences. A wordset is a group of words that share a structural relationship referred to as a concept link 19. In certain contexts, “wordset” may also refer to an analogous set of concepts 18 representing the words, or a group of their associated CIDs. Regardless of the representation, data parser 11 uses wordsets to form “concept link identifiers.” “Concept link identifiers” or “CLID”s are representations, preferably integers or characters that uniquely identify a wordset. Concept table 13 may be used to store CLIDs and their associated wordsets in a manner analogous to that previously described for CIDs. When constructed in this manner, concept table 13 may be used to store every wordset and associated unique CLID previously processed by data parser 11. Concept table 13 may then be used as a lookup table to identify or assign CLIDs to newly processed wordsets, as described in greater detail below. It will be immediately obvious to one of skill in the art that CLIDS may also relate to linked CIDS, as a wordset is simply a representation of conceptually linked words, each of which may be assigned a CID.

Once created, CLIDs are linked to form statements 20. A statement 20 is simply a linked list of all CLIDs formed from a single sentence. The CLIDS in a statement 20 are linked according to the first word of the wordset from which the CLID was formed. All statements 20 from a normalized document feed 16 are associated with the sentence in parsed sentence table 17 the statement 20 represents to create sentence table 14. Sentence table 14 is then associated with document 12 created from the same source data 10 ultimately giving rise to sentence table 14.

Sentence table 14, concept table 13, and documents 12 are preserved in structured data 15. It is obvious to one of skill in the art that the data structures used in implementing data parser 11 and structured data 15 have several equivalent embodiments in addition to those explicitly described herein. For example, sentence table 14 may be associated with document 12 as a data field of document 12, in which case only document 12 and concept table 13 need be preserved in structured data 15. It will also be immediately apparent to those of skill in the art that sentence table 14 may be implemented in a variety of ways in addition to those described explicitly herein. For example, sentence table 14 may be implemented as a single universal table containing representations for all parsed sentences. Such alternative embodiments are contemplated as part of the present invention. Thus, with regard to data parser 11 and structured data 15, the limitations of the present invention are:
1. the assignment of a unique CLID to each unique wordset,
2. the construction of statements and documents,
3. the association of related statements, sentences and documents, and
4. preservation of the data in 1-3 above in a form that may be accessed and searched.

B. Data Input and Normalization

With reference to FIG. 6B, the first step of the data parser aspect of the present invention is to receive source data 10 and process it into a normalized document feed 16. As noted previously, source data 10 of the present invention may originate from any data source contemplated for use with the present invention. In addition to being processed to create normalized document feeds 16, source data 10 may optionally be archived on a local data storage device. Archiving source data 10 in this manner allows, inter alia, for subsequent rapid retrieval of the source data 10. Such archival storage however is typically only beneficial when the source data to be stored is of a known, manageable size, and the origin of source data 10 is generally not readily or efficiently accessible. The original sources of source data 10 may be polled over time for new source data. When new source data 10 are found, they may be retrieved and processed as described herein. The source data 10 may be retrieved in segments if the source data 10 exceeds an optional programmatic threshold size. In the event this optional procedure is implemented, each segment may be processed as separate source data 10.

As noted above, source data 10 may arrive in any format, including unknown formats, which must be normalized prior to encoding in structured data 15. Removing extraneous characters and code from source data 10 described above creates normalized document feeds 16. The purpose of this process is to convert the source data 10 into a series of sentences that may be parsed into individual sentences by the data parser of the invention. By way of example, normalization may include removing XML codes from web pages; converting Unicode characters to regular ASCII text, removing footnote and endnote IDs, and the like. Normalization techniques may be performed in a number of ways, the principles of which are generally known in the art, for example in the case of web pages the following techniques may be used:
1. deriving the normalized document feed by use of a ‘delta’ technique which compares the source data to an empty or null web page;
2. recognizing the various types of data by ‘positional information’, tags or sequence;
3. comparing a raw data file to a data template for the raw data feed to extract nontemplate data. If a particular web site is used a great deal, it may be more reliable to create a special template tailored to remove the formatting code from its corresponding web pages; or
4. extracting the formatting codes from a markup language data file (such as HTML or XML) to obtain the normalized document feed.

C. Data Storage

Structured data 15 serves as a repository for three types of data, each of which is described in detail herein: Documents 12, concept table 13, and sentence tables 14. Structured data 15 may optionally serve other functions, such as a temporary data store for use by, for example, data parser 11 or query agent 33.

Structurally, structured data 15 may take any form suitable for storage and retrieval of digitized content. Generally at least an aspect of structured data 15 must have read/write capability. Other aspects of structured data 15 may be read only or optionally possess other attributes. Structured data 15 may be media, or an entire system capable of communication with other systems and having read/write functionality to a suitable data storage device. Such systems may be dedicated to data storage or more general in nature. Several suitable examples of suitable media for structured data 15 are known in the art and obvious to those of skill in the art. Some of these examples are discussed elsewhere in this specification in relation to other data storage elements.

Structured data 15 may be linked to data parser 11 and/or query agent 33 by any means known to those of skill in the art, including wirelessly or wired. By way of example, structured data 15 may be linked to data parser 11 and/or query agent 33 where data parser 11 and/or query agent 33 are encoded in read-only memory of a computer and structured data 15 is in the physical form of a local hard drive, with structured data 15 and data parser 11 and/or query agent 33 associated via a common bus known to those of skill in the art. Alternatively, data parser 11 and/or query agent 33 may be physically remote from structured data 15, and functionally connected via a LAN, WAN, wireless connection, or some other communication system known in the art.

1. Parsing Sentences

Isolating Sentences from a Normalized Document

Referring again to FIG. 6, once the source data 10 has been processed to create a normalized document feed 16, the normalized document feed 16 is parsed to extract one or more sentences. These sentences are placed in a parsed sentence table 17, preferably in the order in which they appear in the normalized document feed 16. Each normalized document feed has a separate parsed sentence table 17. It should be noted that parsed sentence table 17 is an abstract data structure used to illustrate a transitional step in the present invention. One of skill in the art will readily recognize numerous ways to implement parsed sentence table 17, and as such the discussion of parsed sentence table 17 in this specification should not be considered in any way limiting to the present invention.

Extraction of sentences may be performed by any suitable method known in the art. For example, Lingua:: EN:: Sentence is a publicly available PERL Module, described in Appendix A to priority application Ser. No. 11/096,118, and publicly available over the World Wide Web at www.cpan.org. Sentences as defined herein that may be included in parsed sentence table 17 include, but are not limited to, sentences originally found in the body of the source data 10, as well as in tables, charts, footnotes, endnotes, captions and the like of source data 10.

Verification of sentence validity may also be performed using suitable methods known to those of skill in the art, for example byte frequency analysis may be used. An exemplary byte frequency method is detailed in M. McDaniel, et al., Content Based File Type Detection Algorithms, in Proceedings of the 36^{th} Hawaii International Conference on System Sciences, IEEE 2002, herein incorporated by reference.

As noted above, one purpose for sentence parsing is to provide the textual answers that may be presented to users in response to a query 60. In an effort to provide meaningful answers, the present invention preferably restricts the length of sentences stored in sentence table 14. Thus sentences stored in sentence table 14 of the present invention are preferably limited to less than 1000 characters, preferably less than 900, 800, 700 or 600 characters, and are ideally no more than 512 characters in length. Conversely, sentences also must long enough to communicate a response 61. Accordingly, sentences stored in the sentence table 14 of the present invention should be at least 3, more preferably 5, 6, 7, 8, 9 or 10 characters in length. In preferred embodiments of the invention sentences outside the parameters noted above are ignored and not included in parsed sentence table 17 and consequently may be excluded from sentence table 14. In preferred embodiments of the present invention, quotations may be handled as a single sentence for purposes of storing and searching. In alternative embodiments, where a quotation consists of multiple sentences, each sentence may be parsed, processed, and stored separately.

Sentences that are identified and validated using the criteria discussed above are included in the parsed sentence table 17, and may be used in constructing sentence table 14, as discussed below.

Isolating Word and Concepts from Sentences

Once parsed sentence table 17 is complete, each sentence of parsed sentence table 17 is further parsed into its structural components. These structural components may be defined as constituent words of the sentence, their parts of speech, and their structural relationship to other words in the same sentence, or in some cases their relationships to words in other sentences, for example, pronouns. Parsing each word of the sentence and identifying their relationship my be accomplished using any suitable method, for example with a statistically-based parser or a grammar-based parser. Statistical parsers are known in the art, and register the frequency of words and the combination of word pairs in the text to mathematically determine a data structure. Grammatical parsers are also known in the art and include the Link Grammar Parser (LGP or LGP parser), Version 4.1b, available from Carnegie Mellon University, Pittsburgh, Pa., or a hybrid parser possessing functionality taken from both a grammar-based and statistical-based parser may be used. The LGP parser is discussed at length in the document entitled: An Introduction to the Link Grammar Parser, and in the document entitled: The Link Parser Application Program Interface (API), attached as Appendix C hereto, both documents available on the World Wide Web at http://www.link.cs.cmu.edu/link/dict/introduction.html and presented in to priority application Ser. No. 11/096,118. Another example of a parser type is a genetic parser, which is a hybrid borrowing from grammar-based and statistical parsers. In one embodiment, a genetic parser may perform in the manner of a statistically based parser as described above trained to utilize a valid grammatical dataset, such as that derived from a grammar-based parser.

The parsing process preferably outputs all words contained in the sentence, identifying their parts of speech (where appropriate), and the structural and/or syntactic relationships between each word and other words making up the sentence. By way of example, a grammar-based parser parses each word from the sentence, determines the grammatical type of the word (“concept sense” E.g., “n” (noun), “v” (verb) etc. . . . ), and assigns to the word a link type that is relative to every other word in the sentence the word has a relationship to. E.g., the LGP parser would generate the following output for the sentence “The current security level is orange.”:

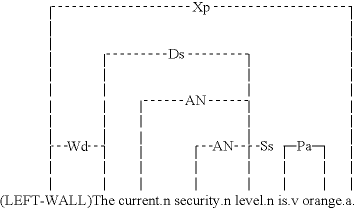

Note that the period (end punctuation) and capitalization of the first word are preserved in the ordered list of words composing the sentence. If the parser skips some words or punctuation, those elements must be in the sentence. The parse above could be represented by:

TABLE 1

| | | |
|---|---|---|
| The.nil | level.n | Ds |
| current.n | level.n | AN |
| security.n | level.n | AN |
| level.n | is.v | Ss |
| is.v | orange.a | Pa |

In some instances the word may not have a concept sense, in which case the assigned concept sense is “nil.” Each instance of a word having a given concept sense is termed a “concept.” Each concept is assigned a unique identifier termed a “concept identifier” or “CID.” For purposes of the present invention a CID may be any unique identifier such as a character, string of characters, or a number (integer or real). Preferably CID's are integers. A table of all CID's is maintained in structured data 15 as part of concept table 13. For example, assuming Table 1 is the first parse of a sentence to be included in the structured data 15, the relevant portion of concept table 13 could be represented as:

TABLE 2

| | |
|---|---|
| The.nil | CID1 |
| current.n | CID2 |
| security.n | CID3 |
| level.n | CID4 |
| is.v | CID5 |
| orange.a | CID6 |

In the instance of an initial parse and construction of the structured data 15 CID1-CID6, together with their associated concepts as depicted in Table 2, could be stored in concept table 13 (see FIG. 6B). In the more general instance where structured data 15 contains a pre-existing concept table 13, a search of concept table 13 could be performed to determine if a concept produced from the parse had already been assigned a CID. If the concept is present in concept table 13, then the associated CID from the concept table 13 could be used. If the concept is not present in concept table 13 then the next available unique CID could be assigned to the concept, and the CID and associated concept stored in concept table 13.

The concept table 13 may optionally contain a concept counter for each concept stored in the table. The concept counter functions by incrementing itself each time a concept is identified in a sentence. Thus the concept counter indicates the number of instances a given concept has been found in all parsed sentences from conception of structured data 15. The importance of optional counters in practicing the present invention is discussed in detail, below.

It should also be noted that both the word and the concept sense of the word are important in assigning the CID. For example in the sentence “An orange is orange.” The word “orange” is used both as a noun and as an adjective, thus “orange.n” would be assigned a separate, unique CID from “orange.a.” As noted below, a concept identifier is assigned to each word of each wordset such that the concept identifier identifies a relationship between the word and other words in the wordset.

2. Wordsets and Concept Linkage

As is readily apparent from the example of Tables 1 and 2, each word in a sentence may have a structural relationship to one or more other words in the sentence. There may also be instances where a word of a sentence has no relationship with any other word in the sentence other than as being part of the same sentence. These structural relationships are identified in Table I by two-letter designations, e.g., Ds, AN, Ss, and Pa, and are preferably identified during sentence parsing. The structural relationship designations identified above are described fully in the appendices of priority application Ser. No. 11/096,118.

Groups of words that share such a common structural relationship are called “wordsets.” For example, {current.n, security.n, level.n} could be one word set, for a scheme utilizing wordsets of either three or a variable number of members. Note that the order of the members in a wordset is significant, and is the same order as the members of the wordset appear in the original sentence. Thus wordsets may contain any number of members, provided the members of the set share a common structural relationship. Wordsets of the present invention preferably contain two members but may more generally be defined as including a plurality of words where the words within each wordset are structurally related and spatially orientated in the same order within the wordset as in the sentence, and all words in the sentence are a member of at least one wordset derived from the sentence.

Wordsets are important in practicing the present invention as they provide structurally significant relationship context to structured data 15. By recognizing structural relationships between words in a sentence, the present invention enhances the indexing capabilities of the structured data 15, which speeds identification of stored data being sought. Wordsets also dramatically improve the specificity and accuracy of the responses 61 provided in answer to a query 60. Preferably wordsets of the present invention are encoded in a manner similar to that previously described for CIDs. I.e., each unique wordset is assigned a unique identifier, termed a “concept link identifier,” or “CLID,” and also referred to as a “concept link.” (FIG. 6B, concept links 19). Using the sentence example above and a preferred two-member word set, the CLIDs generated from the data in Tables 1 and 2 would be:

TABLE 3

| | | | | | |
|---|---|---|---|---|---|
| The.nil | CID1 | level.n | CID4 | Ds | CLID1 |
| current.n | CID2 | level.n | CID4 | AN | CLID2 |
| security.n | CID3 | level.n | CID4 | AN | CLID3 |
| level.n | CID4 | is.v | CID5 | Ss | CLID4 |
| is.v | CID5 | orange.a | CID6 | Pa | CLID5 |

An aspect of the present invention is that CLIDs are sensitive to the spatial relationship, within the original sentence, of the corresponding concepts (and corresponding CIDs) that they represent. This feature is a direct consequence of CLIDs originating from wordsets. For example, a subsequent wordset {level, security} with a corresponding CID set of CID4, CID3 would not correspond to CLID3 (CID set CID3, CID4), and would be assigned a unique CLID (e.g., CLID6). Thus the CLID for each wordset uniquely identifies the spatial orientation, and optionally the value, of the concept identifier(s) of the wordset.

The relationship of CLIDs to wordsets also contributes substantially to encoding of the structural relationship of the concepts found in the original document. This is an important aspect of the present invention as it substantially enhances the relevancy of the search results and response(s) 61 provided for a query 60. Accordingly, as mentioned above, a CLIDs of the present invention may be associated with wordsets of any size, provided the members of a given wordset share a common structural relationship as described herein.

Where a wordset contains more than two members, a CLID of the present invention may also be assigned to additional wordsets which are subsets of the larger wordset. These subset wordsets follow the same rules as all wordsets. By way of example, the sentence above includes the three member wordset {current.n, security.n, level.n}. This three member wordset may be assigned CLIDX. As is illustrated in the parse presented above however, the concepts current.n, and level.n of the three member wordset also share a structural relationship. These concepts thus form a sub wordset {current.n, level.n}, which may be assigned CLIDY. In an analogous fashion, the concepts security.n, and level.n form another subwordset {security.n, level.n}, which may be assigned CLIDZ. Member concepts current.n, and security.n however do not share a structural relationship with each other however independent of concept level.n, and therefore current.n, and security.n do not meet the requirements to establish a wordset independent of the concept level.n in our example.

It will be appreciated by one of skill in the art that where hierarchical wordsets exist, as described immediately above, there may be the potential to rate answer relevancy based on the wordset of the hierarchy that is matched in the query process depicted schematically in FIG. 7. Relevancy ranking of response(s) 61 is discussed in detail below.

As noted above, the example presented in Tables 1-3 assumes that the generated sentences, concepts, CIDs and CLIDs discussed above are the first population of these data types to be stored in structured data 15. More generally, structured data 15 will have been previously populated with data generated from earlier parses. Thus in a more general sense CLIDs will be assigned to CID sets using a methodology analogous to that previously described for assigning CIDs to concepts. The first step of this methodology involves forming a CID set by assigning a CID to each concept formed from a wordset. The order of the CIDs in the CID set are the same as the word order in the corresponding wordset. Concept table 13 is then screened for a previous entry of the newly-formed CID set. If the CID set is found in concept table 13, then the CLID corresponding to the CID set is assigned. If the CID set is not found in concept table 13 then the CID set is assigned a unique CLID, with the new CLID and corresponding CID set being appended to concept table 13.

In optional embodiments of the present invention, CLIDs stored in concept table 13 are accompanied by the structural relationship between the members of the wordset from which the CLID is generated. These structural relationships are termed “link types” and are illustrated in Table I by the two-letter designations Ds, AN, Ss and Pa. As will be appreciated by one of skill in the art, knowledge of the structural relationship between members of a wordset associated CLID may aid in validating the recorded relationship between the words and may provide an indication of the relevance between a response 61 to a given query 60.

Link Validation

Certain optional embodiments of the present invention may also include validation of concept links 19. One approach to validation involves examining concepts and their respective positions in a wordset. By way of example, the examination could be performed using simple Boolean sorting, e.g. for any structurally related pair of concepts in a wordset;
IF the end or second concept is a noun, THEN, make the concept link 19 VALID; OR
IF the end or second concept is a verb, AND the start or first concept is a noun OR an adverb, THEN, make the concept link 19 VALID; OR
OTHERWISE, make the concept link 19 INVALID.
If the second concept of the related pair is a noun, the concept link 19 is always valid. However, if the second concept is a verb, the first concept must be either a noun or adverb, for the concept link 19 to be valid. Otherwise, the concept link 19 is invalid.

Wordsets having more than two members may optionally be validated by validating related pairs of concepts forming sub wordsets from the wordset. In such a scheme, every such sub wordset of the wordset having more than two members must be valid, according to the rules above, in order for the wordset having more than two members, or any sub wordset derived from it, to be valid.

Another method for validating concept links 19 involves a simple comparison of the concepts 18 forming the concept link to a lookup table. This method may be used in conjunction with or independently from other validation methods, including the method just described above. In this second approach pairs of structurally related concepts 18 are evaluated for validity. A concept link 19 is determined to be valid or invalid based simply on the word portion of the concept 18 and its position in a two member wordset. If either concept 18 is determined to be in an invalid position, the entire concept link 19 is considered invalid. An exemplary lookup table is presented in Table 4, below:

TABLE 4

| concept name | start concept | end concept |
|---|---|---|
| a | VALID | INVALID |
| about | VALID | INVALID |
| an | VALID | INVALID |
| and | INVALID | INVALID |
| are | VALID | VALID |
| as | INVALID | INVALID |
| at | VALID | INVALID |
| be | VALID | INVALID |
| but | INVALID | INVALID |
| by | VALID | INVALID |
| do | INVALID | INVALID |
| for | VALID | VALID |
| from | VALID | VALID |
| have | VALID | VALID |
| how | VALID | INVALID |
| i | VALID | INVALID |
| if | INVALID | INVALID |
| in | INVALID | INVALID |
| is | VALID | VALID |
| it | VALID | INVALID |
| not | VALID | VALID |
| of | INVALID | VALID |
| on | INVALID | VALID |
| or | INVALID | INVALID |
| out | VALID | VALID |
| so | INVALID | INVALID |
| that | INVALID | INVALID |
| the | VALID | INVALID |
| this | VALID | INVALID |
| to | INVALID | INVALID |
| was | VALID | VALID |
| we | VALID | INVALID |
| what | VALID | INVALID |
| when | INVALID | INVALID |
| where | INVALID | INVALID |
| which | INVALID | INVALID |
| with | VALID | INVALID |
| you | VALID | INVALID |
| , | INVALID | INVALID |
| : | INVALID | INVALID |
| ; | INVALID | INVALID |
| ! | INVALID | INVALID |
| ? | INVALID | INVALID |
| @ | INVALID | INVALID |
| * | INVALID | INVALID |

Concept links 19 built from wordsets having more than two members are evaluated by first creating two-member sub wordsets as described above. Each two-member sub wordset is then evaluated. If any of the two-member sub wordsets are determined to be invalid, all of the related two-member sub wordsets and the wordset having more than two members from whom they are derived are invalid and the corresponding concept links 19 marked invalid.

Invalid concept links 19 are generally ignored as errors in grammar or spelling. Validity tags as discussed herein are typically associated with their respective concept links 19 and stored in structured data 15.

Concept and Concept Link Counts

Certain optional embodiments of the present invention include concept counters and concept link counters that track each time a given concept or concept link is encountered in a sentence parse. When employed, counters are associated with their respective concepts or concept links and stored in structured data 15. Concept and concept link counts are typically used to classify existing words into parts of speech not traditionally associated with these words, but whose usage may have changed in accordance with contemporary language.

Statements

Statements 20 represent structural relationships between the words in the sentences, and in particular, a collection of structural relationships between the words or concepts 18 of the sentence from which they were taken. Linking CLIDs in the order in which the first concept of each CLID appears in the original parsed sentence forms statements 20. The CLIDs of the statement 20 are therefore spatially related to each according to the position in the sentence of the respective first word of the wordset from which each CLID was formed. An exemplary statement formed from Table 3 would be: {[CLID1] [CLID2] [CLID3] [CLID4] [CLID5]}.

3. Sentence Tables

A sentence table 14 is a data structure that catalogs every sentence parsed from a normalized document feed 16 together with the associated statements 20. Thus, in simplest form, a sentence table 14 contains a document identifier 30, such as an integer, character, string or characters and the like; and a series of entries where each entry contains a character string that is a parsed sentence, as described above, and a statement 20 derived from the associated parsed sentence. The entries in sentence table 14 may be arranged in a manner that identifies the order that the sentences appear in the normalized document feed 16. Optionally, the order that each sentence appears in the normalized document feed 16 may be associated explicitly with each entry in the sentence table. Of course optional features described herein as being available with other data representations (statements, CIDs, CLIDs, etc) associated with the sentence table 14 may also be optionally included in sentences table 14.

During processing of a normalized document feed 16 as described herein, the corresponding sentence table 14 may be stored in a temporary buffer until its construction is complete. Regardless of the particular mechanics in constructing sentence table 14, sentence table 14 is stored in structured data 15 once sentence table 14 has been completed, as depicted in FIG. 6.

4. Documents

A document 12, as used herein, is a data structure containing information about the source data 10. Each document 12 is associated with a sentence table 14 by a document identifier 30 that is commonly available through both the document 12 and associated sentence table 14. The document identifier 30 may be any data type as described previously. By way of example, in computer memory architecture, the document identifier 30 may be the memory address of the first character in the associated sentence table 14. In this exemplary scheme, document 12 would store the document identifier 30 as a memory address (I.e., as a pointer to sentence table 14). Conversely, the document identifier 30 would be inherent to the sentence table and could be retrieved simply by requesting the address of the first character of sentence table 14 themselves.

FIG. 8 is a diagrammatic representation of document 12. Of the fields 30-37 presented in FIG. 8, only Document ID (identifier) 30 and URL 36 are necessary for the operation of the present invention. URL 36 is simply an address in appropriate form that allows for retrieval of the source data 10. All other fields that may be included in document 12 are optional and may be included for informational purposes, document tracking, updating and the like. For example, fields 31-35 and 27 may be included for ranking the authority of the source data 10 against other source data 10. In addition to optional fields represented by grayed titles in FIG. 8, other fields obvious to one of skill in the art may also be optionally included in document 12 and each is contemplated as being part of the present invention. Whether essential or optional, each field in document 12 may be populated from the information in source data 10. Any field of document 12 that cannot be populated from the information in source data 10 is suitably marked to indicate the field in question is <empty.>.

The optional field content 37 may take a variety of forms. For example, in some embodiments of the present invention, content 37 may be a cached copy of source data 10. In other embodiments, content 37 may be sentence table 14.

As depicted in FIG. 6B, an initial step in the processing of the source data 10 involves checking documents 12 in structured data 15 for an earlier entry in the database for the source data 10. Earlier entries are typically detected by inspection of the URL 36 field of documents 12 in structured data 15. If the new source data 10 has an identical source location to that entered in field URL 36 of an existing document 12 in structured data 15, then the pending source data 10 may have already been entered into the database. Thus when this situation occurs in some embodiments of the present invention, data parser 11 will discard the pending source data 10. However, another likely scenario in this situation is that source data 10 represents and updated raw data. In this latter case the document existing in the database should be replaced with the updated information. This replacement with potentially updated information is the preferred embodiment of the present invention and is accomplished by first discarding the currently stored document 12 and the associated sentence table 14. The pending source data 10 is then processed as described below, replacing he old document 12 and the associated sentence table 14 entries.

Certain source data 10 are split or sectioned into two or more source data 10 to improve performance of the invention. Dividing source data 10 in this manner may result in multiple source data 10 being identified as located at the same source by, for example, URL 36 of document 12.

Documents 12 are stored in structured data 15 where they may be identified using any suitable retrieval technique known to one of skill in the art.

IV. Query Agent

A. General Operation

Query agent 33 of the present invention accepts a query 60 from a user, processes the query to identify a best response, which includes searching a structured database, and returns at least the best response identified to the user. This basic process is presented diagrammatically in FIG. 7A. Query agent 33 may not itself be implemented at one location. For example, the process accepting query 60 may be located as part of one system, the parser that processes the query, as described below, may be located as part of a second system, and the search component that identifies at least the best response to be returned to the user may be part of a third system. Similarly, structured data 15, which stores the structured database(s) of the present invention may also be located as part of a separate system. FIG. 7B illustrates schematically the general steps in implementing query agent 33. These steps are discussed in greater detail, below.

B. Generating Search Statements

Search statements 59, as used herein, are ordered lists of CLIDs analogous to those described elsewhere in this document as statements 20. Search statements 59 differ from statements 20 in that search statements 59 are generated by parsing a query 60 using parsing methods of the invention as described herein. In contrast, statements 20 are generated by using parsing methods of the invention on sentences generated from normalized feeds 16 produced from raw data.

Search statements 59 are generated by query agent 33 as an intermediate structure in the process of identifying sentences taken from a knowledge source that match a query 60. This is illustrated diagrammatically in FIG. 7B. The process involves first parsing a query 60 to identify word types. Each word in the query taken with its word type is termed a “concept.” Next the present invention determines structural relationships between concepts 18 in the query 60. Groups of concepts sharing a common structural relationship are termed “wordsets.” Each unique wordset is assigned an identifier termed a concept link identifier or “CLID.” CLIDs assigned to wordsets generated from a query 60 are taken from concept table 13 stored in structured data 15. If a wordset generated from a query 60 is not represented in concept table 13, then the wordset may be ignored, or preferably is assigned an <empty> or “NULL CLID. CLIDs 19 generated in this manner are ordered in a string according to where the first word of the wordset associated with the CLID appears in the original query 60. The search statement 59 is then used to search sentence tables 14 to identify a statement 20 that most closely matches the search statement 59. Sentences and documents 12 associated with the identified statement(s) 20 are then used to construct a response 61. Each of these steps is discussed in greater detail, below.

1. Queries

A query 60 of the present invention may be of a variety of types, the only limitation being that query 60 is suitable for parsing into a search statement(s) 59 of the present invention, or be capable of transformation into data suitable for parsing into a search statement(s) 59 of the present invention. By way of example, query 60 may be digitized text, such as a collection of keystrokes entered at a computer keyboard. Alternatively, query 60 may be handwritten for example on a graphics pad. The handwritten query 60 may then be translated into a normalized format suitable for processing by query agent 33.

A query 60 may also be in audio form, which again could be translated into a normalized format suitable for processing by query agent 33. Thus for example a query may be made as part of a telephone call or conversation. The user may answer an audible question provided by the present invention or other source. The present invention may then transform the answer to the question into a digitized textual form that may be processed by query agent 33. Using methods available in the art, the present invention may process audible data for use in the present invention both in the form of complete files and as part of an audio stream. A suitable query 60 of the present invention may be presented in any format, provided that the query 60 may be processed by the present invention to produce at least one CLID either with or without conversion to a normalized format suitable for processing by query agent 33. A preferable normalized format for query 60 is Natural Language Format (“NLF”).

Queries may be presented either directly to query agent 33 (e.g., as text files transferred between computers) or may be presented to query agent 33 via a suitable user interface, as described in detail below.

2. Parsing Queries

A query 60 of the present invention is parsed using the same parsing methodology as previously described for data parser 11, to create a search statement 59. It is important to note that in processing the query, every word of the query is utilized to enhance the accuracy of the result returned from structured data store 15, and ultimately the knowledge source, e.g., elements 30, 31 and 32 of FIGS. 1A-C. I.e., a set of query word relationships is established for each word in the query, and these word relationships are used in identifying prospective query responses by including encoded representations of the word relationships in the search statement 59.

By way of example, an exemplary query 60 may be, “What is the current security level?” Query agent 33 would parse this query 60, using for example the LGP described above for the data parser 11, to:

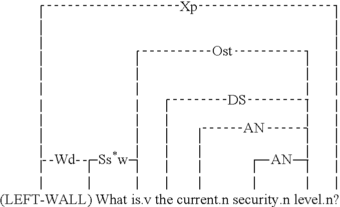

This parse may be represented by:

TABLE 5

| | | |
|---|---|---|
| What.nil | is.v | Ss*w |
| is.v | level.n | Ost |
| the.nil | level.n | Ds |
| current.n | level.n | AN |
| security.n | level.n | AN |

As is evident from Table 5 and the exemplary query parse, the parse performed by the query agent 33 follows identical rules to those followed by data parser 11. As previously described for data parser 11, CLIDs are now formed from wordsets composed of members having a common structural relationship. Were a CLID has already been assigned to a given wordset and recorded in concept table 13, that CLID will be used for the wordset. For example, {the.nil, level.n}, {current.n, level.n}, and {security.n. level.n} would be assigned CLID1, CLID2, and CLID3 respectively, based on the previous parse example noted above in the sections describing data parser 11.

If the same parse was the only source of data in concept table 13, then concept table 13 would not contain wordsets {What.nil, is.v} and {is.v, level.n}, nor corresponding CLIDs for these wordsets. The query agent 33 may handle this situation in one of two ways: Query agent 33 may simply ignore these wordsets as they do not appear in structured data 15 and therefore are not associated with entries in the data source that have been encoded by data parser 11; Alternatively, and preferably, the new wordsets may be assigned unique CLIDs. Under no circumstances should query agent 33 modify any data in structured data 15. Thus, in preferred embodiments where unique CLIDs are assigned to wordsets, the new CLIDs and wordsets should not be added to concept table 13. The reason assignment of unique CLIDs is preferred even though they do not exist in structured data 15 relates to certain embodiments of the invention that perform ranking and/or relevance determination(s) on data prior to returning a response. Ranking and relevance determinations are discussed in detail, below. By way of example, using the examples previously provided, the following two-member wordsets would be formed from the example query 60:

TABLE 6

| | | | |
|---|---|---|---|
| What.nil | is.v | Ss*w | CLID7 |
| is.v | level.n | Ost | CLID8 |
| the.nil | level.n | Ds | CLID1 |
| current.n | level.n | AN | CLID2 |
| security.n | level.n | AN | CLID3 |

As noted above, wordsets formed from a query may have more than two members, where all members of the wordset share a common structural relationship. For example, referring to Table 6, the wordset {current.n, security.n, level.n} shares the concept link “AN” and may be assigned CLID9.

Table 6 also highlights the ability of the present invention to differentiate as to the question being asked. As depicted in Table 6, CLID7 is associated with the wordset {What.nil, is.v}. According to the present invention, this identifier is unique from the identifier assigned to the wordsets {Where.nil, is.v} or {Who.nil, is.v}. Thus, unlike other approaches, the present invention can distinguish between the questions “Where is Niagara Falls?” and “What is Niagara Falls?” This unique ability of the present invention to distinguish subtle differences in the wording of the question has significant implications on the accuracy of the answers provided by the invention to the user, and in many cases is the difference between a useful answer and a nonsensical one.

Note also that CLIDs formed by query agent 33 are validated, as described above. Validation of CLIDs from wordsets having more than two members is performed in an identical manner to that previously described. As with statements 20, only validated CLIDs are preferably used to form the search statement 59.

Once CLIDs are determined for query 60, they may be arranged to form the search statement 59 in a manner analogous to that described for statements 20, above: I.e., the CLIDs are arranged in the search statement 59 in the same order as the first word of each CLID appears in the query 60 that is encoded by the search statement 59. Thus a search statement 59 is analogous to a statement 20 described above. For example, the search statement (using 2-member wordsets) constructed for Table 6 would be {CLID7, CLID8, CLID1, CLID2, CLID3}. If we included wordsets with more than two members, the search statement 59 would be {CLID7, CLID8, CLID1, CLID9, {CLID2, CLID3}}. Note that in statements constructed using wordsets with more than two members, the CLID corresponding to the wordset with the greater number of members appears in the statement before smaller wordsets that are subwordsets of the wordset with the greater number of members. In the example above, the subwordset CLIDs are bracketed (CLID2 and CLID 3). The same rules hold when constructing statements 20 using data parser 11 discussed above. Query agent 33 may then search the structured data store using the search statement 59, as described immediately below.

3. Searching Structured Data

Structured data 15 may be searched by query agent 33 through comparison of the search statement 59 constructed as described above to statements 20 preserved in structured data 15. Any statement 20 that includes a CLID found in the search statement 59 may be considered a “match” and may be marked as part of an appropriate response 61 to the query 60. As each statement is linked to the sentence it encodes through sentence table 14, sentence table 14 is related to a document 12 by a document identifier, and document 12 contains information related to the original knowledge source that gave rise to the sentence table 14 (including the location of the knowledge source), identification of a matching statement 20 allows query agent 33 to retrieve pertinent information regarding the original knowledge source in addition to the sentence encoded by matching statement 20. Thus structured data 15 serves as a relational database including condensed information relating to a plurality of knowledge sources. Therefore, matching a statement 20 to a query 60 allows a user to retrieve any or all information desired from the original knowledge source that gave rise to matching statement 20.

As described below, the more CLIDs matched between a search statement 59 and a statement 20, the more relevant the response 61 to query 60. Moreover, matching multiple CLIDs in statement 20 in the same order they appear in the search statement 59 further enhances relevancy. The reasons for this are discussed below for optional embodiments of the invention that rank search results based on relevancy.

C. Response

Once a search of structured data 15 has been completed, the results of the search may be used to construct a response 61 that will ultimately be returned to the user issuing the query 60 that commenced the search process. As indicated in FIG. 7B, constructing a response 61 includes selecting sentences and documents 66 associated with statements 20 that were identified as matching one or more members of a powerset (Step 65 in FIG. 7B). Thus response 61 typically comprises at least one sentence retrieved from sentence table 14 that is associated with a statement 20 matching at least one member of a powerset built from query 60.

In addition to at least one sentence from a sentence table 14 of structured data 15, the response may optionally include additional information regarding the knowledge source from which the sentence from a sentence table 14 was taken. As discussed above, for each sentence table 14, structured data 15 contains an associated document 12 that contains information regarding the knowledge source from which the sentence table was created. As previously noted, sentence table 14 and document 12 are linked by a document identifier, therefore once one of these data structures is identified, the associated data structures may also be identified. The information stored in document 12 includes the location of the original knowledge source. This location may be a web address, a file path and name, a catalog number, or some other indicator of the location of the original knowledge source. It is important to note that the location of the knowledge source stored in document 12 may be an electronic address, a virtual address, a physical location such as the shelf upon which a book is located, or some other location type. Therefore, any or all information relating to the original knowledge source as recorded in document 12 may also be included in response 61.

Moreover, as document 12 includes the location of the knowledge source, additional information regarding the knowledge source not directly included in document 12 may also be included in response 61, provided that query agent 33 has the ability to access the knowledge source through the information contained in document 12 (or sentence table 14). Optional information that may be included in response 61 includes, but is not limited to, graphics images, text, hyperlinks, applets, survey questions and advertisements. Preferred optional embodiments include a response 61 that includes an indicator of response 61 relevancy to query 60.

Still other optional embodiments of the present invention include response 61 that inform the user that additional responses are available for a fee. Such embodiments may also include means for accepting payment from the user and subsequently allowing the user access to the additional responses. Implementation of an embodiment of this type is obvious to one of skill in the art. By way of example, document 12 of structured data 15 may contain a field identifying the origin of source data 10 as requiring payment of a fee for access. The initial response returned by query agent 33 may only contain sentences associated with documents marked as available for display without a fee in associated document 12. Upon a request for the optional fee-based responses and optional payment of the indicated fees, the relevant responses marked as requiring a fee in document 12 may be provided. Several of these optional elements of response 61 will be discussed in greater detail below.

Access to the knowledge source may also optionally allow query agent 33 to return a response 61 where the sentence is placed in the context it is found in the knowledge source itself. In this case, the sentence may be used to search the knowledge source using methods well known to one of skill in the art. Once found, the sentence may be excised from the knowledge source with surrounding sentences and/or other elements in proximity to the sentence. Context may also be provided to a sentence by simply including other sentences from the sentence table 14 from which the sentence is taken. For example, sentences preceding or subsequent to the sentence corresponding to the statement 20 matched during the search process may be included in response 61 to provide context.

Responses 61 of the present invention may be returned to a user in any suitable format, e.g., as printed or graphically displayed text, images, constructed voice responses and the like. Responses 61 may be transmitted by any suitable communication protocol or medium, e.g., via communication between electronic devices, FAX, e-mail, telephone, postal or telegram services and the like.

FIG. 10b illustrates a simple example of one embodiment of the present invention. In the example provided in FIG. 10b, the user asks the question “Does God exist?” The present invention returns a response 61 that includes three sentences. Each sentence is from a different sentence table and consequently a different knowledge source as indicated by the optional hypertext link to each knowledge source following each sentence. The response also prompts the user with the optional survey question “How'd we do?” for each returned sentence of response 61.

1. Ranking/Relevancy of Responses

As discussed previously, the present invention encodes structural relationships between words in a sentence in a manner that is effectively lossless. The present invention utilizes these encoded structural relationships to identify statements 20 that relate to search statement(s) 59 provided by a user. Where more than one statement 20 is identified as matching a search statement 59, it is preferable that the statements be ranked in order of relevancy so that the user may be furnished with at least the best response 61 to query 60. The novel approach to encoding language taken by the present invention makes optional relevance ranking simple, as well as more accurate than previous approaches of evaluating information. Accordingly, preferred embodiments of the present invention rank responses 61 in a relevancy order based on user-defined or pre-defined criteria. Typical relevancy criteria contemplated as useful with the present invention includes, but is not limited to, percent matches between statement 20 and search query; ranking based on the knowledge source of the response 61; and relational relevancy, for example the ability to rank responses 61 based on user-preferences, dialogue context or other user interactions, and the like.

a. Using Powersets

One approach to relevancy ranking utilizes “powersets.” A “powerset” is simply a collection of statements representing all permutations of valid CLIDs taken from a search statement 59, with the single proviso that CLIDs in each statement are ordered according to the position where the first word of each wordset represented by the CLID appears in the sentence encoded by the search statement 59.

Ranking response candidates based on powersets takes advantage of the information encoded in statements, i.e., every word in a sentence and query 60 may be encoded according to type in the form of CIDs. The structural relationships between CIDs (e.g., the relationship between nouns or pronouns, modifiers and verbs) are encoded as CLIDs. At the most subtle level, the relationship between CLIDs is preserved in the order the CLIDs appear in a statement. Thus any statement 20 that matches several CLIDs of a search statement 59, including the order of the CLIDs in the search statement 59, is likely to represent a response 61 that is highly relevant to query 60 encoded by the search statement 59.

Master and Power Sets

For purposes of this discussion, the search statement 59 itself is also termed the “master set” and is the source of the powerset. Rules for constructing a power set are straightforward: As noted above, all combinations of CLIDs are used, but the CLIDs must retain their relative order to each other in every statement of the powerset. For example, in some embodiments of the present invention, the powerset from the master set {CLID7, CLID8, CLID1, CLID9, {CLID2, CLID3}} is:

TABLE 7
Exemplary powerset to {CLID7, CLID8, CLID1, CLID9,
{CLID2, CLID3}}

{CLID7, CLID8, CLID1, CLID9}
{CLID7, CLID1, CLID9}
{CLID7, CLID9}
{CLID7, CLID1}
{CLID1, CLID9}
{CLID7}, {CLID8}, {CLID1}, {CLID9}
{CLID7, CLID8, CLID9}
{CLID7, CLID8}
{CLID8, CLID9}
{CLID7, CLID8, CLID1}
{CLID8, CLID1}
{CLID8, CLID1, CLID9}
{CLID7, CLID8, CLID1, CLID2, CLID3}
{CLID7, CLID1, CLID2, CLID3}
{CLID7, CLID2, CLID3}
{CLID7, CLID3}
{CLID7, CLID2}
{CLID2, CLID3}
{CLID7}, {CLID8}, (CLID1}, {CLID2}, {CLID3}
{CLID7, CLID1, CLID3}
{CLID7, CLID3}
{CLID7, CLID1}
{CLID1, CLID3}
{CLID7, CLID1, CLID2}
{CLID1, CLID2}
{CLID1, CLID2, CLID3}
{CLID7, CLID8, CLID2, CLID3}
{CLID7, CLID8, CLID3}
{CLID8, CLID3}
{CLID7, CLID8, CLID1, CLID3}
{CLID7, CLID8, CLID1, CLID2}
{CLID8, CLID2}
{CLID8, CLID1, CLID2, CLID3}
{CLID8, CLID1, CLID2}
{CLID8, CLID1, CLID3}
Note that in the exemplary embodiment above wordset hierarchy is recognized: I.e., the relationship of CLID 9 (from a 3-member wordset), and CLID2 and CLID3 (subwordsets of CLID9) is recognized in that only the superior CLID (CLID 9) or the inferior CLIDs (CLID2 and CLID3) are used in a given substatement of the powerset. Other implementations of the invention are obvious to one of skill in the art, and are contemplated
# as part of the present invention. For example, hierarchy could be ignored and the entire powerset built from the masterset {CLID7, CLID8, CLID1, CLID9, CLID2, CLID3}. Alternatively, only CLIDs from 2-member wordsets could be used, I.e., the exemplary masterset would be {CLID7, CLID8, CLID1, CLID2, CLID3}. Other variant constructions are also contemplated as part of the presently claimed invention.

Searching Structured Data Using a Power Set

Any number or all statements in the powerset may be utilized in the search process, depending upon the requirements of the user. However, it is preferred that statements of the powerset be used in the search in order of their “degree.” “Degree” refers to the number of CLIDS in a statement of a powerset. For example, a statement of the powerset having four CLIDs has a degree of “4.” Statements within a given degree may also be searched based on the continuity of the CLIDs making up the statement. Using a generic example, the search statement {CLIDA, CLIDB, CLIDC, CLIDD, CLIDE, CLIDF} would produce a powerset that included
{CLIDA, CLIDB, CLIDC, CLIDD, CLIDE} and
{CLIDA, CLIDB, CLIDC, CLIDE, CLIDF}
Although both of these powerset statements are of the same degree (five), they differ in the continuity of their CLIDs. The first statement, {CLIDA, CLIDB, CLIDC, CLIDD, CLIDE}, retains continuity, differing from the search statement 59 in being truncated at the last CLID (CLIDF). By comparison, the continuity of the second statement, {CLIDA, CLIDB, CLIDC, CLIDE, CLIDF}has been disturbed as the removed CLID is from the middle of the statement and results in the juxtaposing of CLIDC and CLIDE, a relationship that is not consistent with the search statement 59.

While the above discussion focused on the statements of the powerset, it should be remembered that the important aspect of the search is not the number of CLIDs in the statement used to search structured data 15, nor the continuity of the statement of the powerset used. The important aspect in performing the ranking analysis is how closely a statement(s) 20 from structured data 15 matches the statement used in the search. Thus the powerset approach described above is simply a way of testing how closely a statement 20 of structured data 15 matches a search statement 59.

By way of example, if a statement 20 reads:
{CLIDF, CLIDB, CLIDX, CLIDC, CLIDD, CLIDY, CLIDZ, CLIDE, CLIDS}
   and the search statement 59 reads:
{CLIDA, CLIDB, CLIDC, CLIDD, CLIDE, CLIDF}
   Then the matched CLIDs between the search statement 59 and the statement 20 would be those highlighted in the statement below:

A. {CLIDF, CLIDB, CLIDX, CLIDC, CLIDD, CLIDY, CLIDZ, CLIDE, CLIDS}

While there are five matching CLIDs between the search statement 59 and the statement 20, only two of the matching CLIDs in the statement 20 are in the same order as in the search statement 59 and have no nonmatching CLIDs between them. Therefore, the above exemplary statement 20 matches the power set at degree two. Contrast the example above with the following exemplary statement 20 compared to the same search statement 59:

B. {CLIDF, CLIDX, CLIDB, CLIDC, CLIDD, CLIDY, CLIDZ, CLIDE, CLIDS}

Statement 20 (B) has the same CLIDs and the same matched CLIDs as statement 20 (A). However, CLIDs B-D are retained in the same order and have the same continuity in both the search statement 59 and statement 20 (B). Therefore, statement 20 (B) matches a powerset statement of degree three and has more relevance to the query 60 than Statement 20 (A).

Taking the example one stage further, consider:

C. {CLIDU, CLIDX, CLIDW, CLIDC, CLIDD, CLIDE, CLIDY, CLIDZ, CLIDS}

Statement 20 (C) has only three CLIDs that match CLIDs in the search statement 59. These matching CLIDs are however in the same order, with no intervening nonmatching CLIDs, in both the search statement 59 and statement 20 (C). Therefore, like statement 20 (B), statement 20 (C) matches a powerset statement of degree three. However, in certain optional embodiments of the invention, the total number of CLIDs matching between the statement 20 and the search statement 59 are also considered. In such optional embodiments, statement 20 (B) would be considered to be of more relevance to the query 60 than statement 20 (C) due to the greater number of CLIDs in statement 20 (B) matching the search statement 59. Both statements 20 (B) and (C) would be considered more relevant that statement 20 (A) by virtue of matching a powerset statement of higher degree than matched by statement 20 (A). Additional variants to the above ranking schemes will be obvious to those of skill in the art and are also contemplated as being part of the presently claimed invention.

Searching structured data 15 using the powerset approach is presented diagrammatically in FIG. 7B. Once the CLID powerset 64 is created, CLID matches 65 are identified between powerset members and statements 20 in sentence tables 14 preserved in structured data 15. A “match” occurs whenever a CLID in a powerset member matches a CLID in a statement 20 found in one of the sentence tables 14. It is obvious to one of skill in the art that other match requirements, such as those described above, may also be used in practicing the present invention depending upon the requirements of the user. These variant requirements are also contemplated as being part of the presently claimed invention.

The search may be terminated at any point determined by the user. For example, the search may continue until a given number of matches are obtained, with the resulting matches being ranked using a method described herein before returning a response 61 to the user. Numerous variant search strategies falling within the bounds of the present invention may be contemplated by one of skill in the art and all are considered part of the presently claimed invention. E.g., a simple application of the powerset approach is simply to compare the search statement 59 to each statement 20 in structured data 15. Statements 20 having a threshold number of CLID matches with the search statement 59 will be evaluated with the statement matching the powerset member of the highest degree being the best response 61.

Positional Weighting

In addition to powerset weighting, the present invention may optionally employ positional weighting to the relevancy ranking of CLIDs present in both a statement 20 and a search statement 59. A positional weighting approach may be used alone or in conjunction with any other ranking formula of the present invention.

Positional weighting takes into account the observation that important aspects of a query 60 presented in statement form tend to be found at the beginning of the query 60. Conversely, a query 60 presented in the form of a question tends to have important aspects of the query 60 located toward the end of a sentence. By way of example, consider the following statement/question pair.

A. Niagara Falls is Located in Southern Canada.

B. Where in Canada is Niagara Falls Located?

Both the statement and the question relate to the location of Niagara Falls. Accordingly, the more important wordset in both the statement and the question.is {Niagara Falls.n, located.v}. This wordset (and therefore the corresponding CLID) is located at the beginning of the statement and at the end of the question.

One way to implement a positional weighting scheme would involve giving each section of a query 60 a weighting factor. For example, the first third of a statement or the last third of a question could be given a weighting factor of “1,” the middle third of both types of query 60 given a weighting factor of “0” and the remaining third given a weighting factor of “−1.” In comparing the search statement 59 to a statement 20, statements 20 matching CLIDs of the search statement 59 with a higher weighting factor would be considered more relevant than other search statements 59, all other parameters being equal.

b. Source Data Locations

Another method of rating a response is based on the location of the source data 10. For example, the origin of source data 10 encoded in structured data 15 may be preserved in a lookup table by the present invention. Each of origin may be assigned a pre-determined weighting factor based on the level of authority one of skill in the art would place on a source data 10 taken from the particular origin. When a statement 20 is identified as matching a search statement 59, the origin of source data 10 giving rise to the statement 20 may be determined directly or indirectly from the associated document 12. The weighting factor for the identified origin may then be determined from the lookup table associating origins with weighting factors. Embodiments of the present invention may utilize weighting based on source data 10 origin alone or in conjunction with other ranking schemes as described herein.

c. Relational Associations

The present invention also contemplates improving the relevancy of a response 61 to a query 60 by optionally taking account of user-specific information, the location of the user, political or cultural aspects of the user or any similar informational sources with respect to either the user, the interaction between users, prior user queries 60 and the like.

(i) Using User-Specific Information

One of skill in the art may contemplate several embodiments of the present invention utilizing user-specific information. For example, user-specific information may be ascertained from a questionnaire, previous queries 60 and/or responses 61 to the same, and the like. Such information may be encoded in the form of statements 20 and stored in a relational database similar to that of structured data 15. After statements 20 from a sentence table 14 that match CLIDs of a search statement 59 have been identified, these matched statements may be further evaluated for CLIDs matching those present in statements 20 formed from user-specific information. By way of example, this approach may be used to refine a search by ranking statements of the same degree based on user preferences. Alternatively, structured data 15 may be searched based on user-specific information, with the search result being refined by further processing using a query 60.

(ii) Using Geographic Location

One relational association contemplated for use with the present invention is geographic location. For example, FIG. 11 diagrammatically depicts an embodiment of the present invention that monitors a dialogue 71. The dialogue 71 may be between any two or more users, where a “user” may be a human being, a machine, or a human being operating a machine. Dialogue 71 is monitored by front end 70 that, for example, may be a stand-alone object, part of query agent 33 or part of data parser 11. Front end 70 may monitor any part or all of dialogue 71, but in preferred embodiments allows dialogue 71 to be returned to one or more users as at least a portion of dialogue response 72. In monitoring dialogue 71, embodiments of the present invention using geographic location may identify portions of dialogue 71 referring to geographic vicinity. The geographic vicinity may relate to the location or origin of one or more users, the context of the dialogue, or to some pre-defined aspect desired by the user. Geographic information, as described above, may be stored for later use, e.g., as alternative information 73 in information store 74, or used immediately.

Continuing the example above, when front end 70 detects a query 60 in dialogue 71, the query 60 is passed to query agent 33, as depicted in FIG. 11. In exemplary embodiments, query agent 33 forms a search statement 59 from query 60, as described above, and retrieves at least the best response from structured data 15. Query agent 33 then retrieves geographic location information (e.g., alternative information 73 in FIG. 11) either directly from front end 70 or more preferably from information store 74, where the information store 74 may be part of or independent from structured data 15. Query agent 33 then forms a second query statement from the geographic location information and screens statement(s) 20 of the at least the best response to rank the latter according to relevant geographic location information. Ranked responses are returned as response 61 and either directly or indirectly returned to one or more users as part of dialogue response 72, preferably identified in dialogue response 72 as associated with the query 60 that generated response 61. An exemplary response 61 generated by the present invention in the context of a multi-user dialogue 71 is depicted in FIG. 10B. FIG. 10A depicts an exemplary method for including the present invention in a multi-user dialogue. In the example depicted in 10A, the present invention is listed as a “contact” in an instant messaging contacts list; i.e., as questions@jabber.kozoru.com.

One of skill in the art will recognize that the general approach described above relating to geographic location, and depicted in FIG. 11, may be used to rank response(s) 61 by a variety of alternative information 73 types including, but not limited to, cultural, political, age, chronology, ethnicity and the like.

(iii) Relevancy Tags

Optional embodiments of the present invention include assigning a relevancy tag to a response 61 that may be displayed to the user. Such relevancy tags may be text, graphics, audio feedback or a combination of the same that identifies the relative relevancy of a response 61. Relevancy may be determined based on statement ranking, e.g., as described above, for statements associated with a single response 61, or may be a global relationship based on a predetermined standard applied to all potential responses 61.

By way of example, a simple implementation of relevancy tagging would set a global standard of matching at least 25% of search statement 59 CLIDs with a statement 20 as being the threshold for statement 20 relevancy to the query 60 producing the search statement 59. When a statement 20 matches at least 25% of the search statement 59 CLIDs, then the sentence associated with the statement 20 is returned with a “thumbs up” graphic indicating a relevant response. If the percentage CLID match with the search statement 59 is less than 25%, then a “thumbs down” graphic is returned, indicating that the sentence is uninformative.

One of skill in the art will readily envision more complicated rating systems. For example, the rating system my return a relevancy tag that is the percentage of CLIDs matched between the statement 20 and the search statement 59, a predetermined text message, or the like.

2. Linking Advertising to Responses

The present invention may also include advertisements as part of response 61. In preferred embodiments, the advertisement included with the response 61 is screened to maximize relevancy of the advertisement based on the query 60 from or response 61 to the user.

Implementation of such optional embodiments is obvious to one of skill in the art. By way of example, FIG. 12 depicts one such exemplary implementation. In FIG. 12, a query 60 is processed to produce a search statement 59 as described previously. Advertisements have been previously parsed to statements 20 and the statements 20 and associated sentences from the advertisement stored in advertisement store 81 as advertisement tables 80 in a manner analogous to that of sentence tables 14, as described previously. Advertisement store 81 may be independent from or part of structured data 15. It will be readily apparent to one of skill in the art that, for example, meta-information may be associated with and parsed in lieu of parsing the advertisement text itself. This latter approach is particularly useful when the advertisement is principally or solely composed of graphics images.

The search statement 59 is then compared to statements 20 of advertisement tables 80 and sentence tables 14 by query agent 33. Response 61 is then formed from the advertisement(s) associated with the statement 20 that best matches the query statement, and the knowledge source information associated with the statement 20 from sentence table 14 best matching the search statement 59.

Alternatively, the advertisement may be matched to the statement 20 from sentence table 14 that best matches the search statement 59 formed from query 60. In this approach the search statement 59 is first used to produce a set of matching statements 20 from sentence tables 14. Each of the set of matching statements 20 is then used as a search statement 59 for the advertisement statements of advertisement tables 80. The advertisement statement(s) most closely matching a statement 20 is used with the statement 20 in constructing response 61.

Still another exemplary embodiment of the present invention associates each statement 20 stored in structured data 15 with an advertisement. In this embodiment, an advertisement statement is tested against each statement 20 stored in structured data 15. The advertisement associated with the advertisement statement is then associated with the statement 20 most closely matching the advertisement statement. Association of the advertisement with the statement 20 may be accomplished in a variety of ways, e.g., an identifier for the advertisement may be included as a field in document 12, or as an entry in sentence table 14.

It should be noted that multiple advertisements might be associated with a given response. This may occur for example when multiple advertisement statements match a statement 20 to the same degree, or when multiple advertisement statements meet a certain threshold degree for statement matching.

The present invention also includes optionally charging a client for including an advertisement in a response 61. Such optional charges may be based on a flat rate, a per display or per “hit” basis, based on the size of the advertisement or metadata associated with the advertisement, or may be based on any other suitable arrangement for billing advertisement fees known to one of skill in the art.

The present invention may also optionally return a question or questionnaire as part of a response 61. Such an option is particularly useful where user or other relational information is desired to enhance relevancy of response(s) 61, including relevancy of any advertisement portion of response 61. Information collected by such alternative embodiments includes, but is not limited to personal information, cultural, political, age, chronology, ethnicity and the like. Using the teachings described herein, it will be obvious to one of skill in the art that there are numerous alternatives to implementing the collection of information, e.g., the information from a question or questionnaire may be presented as at least part of a response 61. Answers to the question(s) may be stored as structured data 15, or in an independent data store, or used immediately without interim storage. The answers are processed to form statements that are then used to identify suitable advertisements matching the answers based on statement comparison as described above.

V. Interfaces

The present invention may be practiced with any number of user interfaces known to those of skill in the art. By way of example, the present invention may be implemented through a telephone, Voice-over-IP phone, WiFi phone, personal computer, workstation computer, graphics tablet, hand-held computer and the like. Other suitable devices through which the present invention may be implemented are also known and obvious to those of skill in the art.

Various communications protocol are suitable for use with the present invention. The actual protocol used will be largely or wholly dependent upon the implementation chosen. For example, RSS protocol may be used when the information source of the invention reports weather, traffic, calendar events and the like that are periodically updated. FTP, TCP and other common transmission protocols are also contemplated for use with the present invention. In addition to LAN and WAN networks, including telephone networks, television and radio broadcasts, and the world wide web, the present invention may also be implemented as a stand-alone device. Stand-alone device implementation of the present invention is discussed in detail, below. Preferred embodiments of the present invention include web browser interfaces, Short Message Service (SMS), WiFi communication devices, instant messaging clients, electronic mail, cell phones and the like. Several of these preferred embodiments are discussed in greater detail, below.

A. Web Browsers

Web browsers are well known to those of skill in the art, and may be used with the present invention through a variety of formats. By way of example, the present invention may be implemented through a web browser as an interactive web page, a JAVA® applet, a tool bar field or the like. By way of example, the present invention may be implemented as an interactive web page with a static IP address. Such a web page may include a text input field for receiving a query 60 from a user. Upon receiving a query 60, the web page implementation of the present invention may return a response 61 in a separate field, in the same field associated with the query 60 input, or implemented in a pop-up window. The web site containing the web page implementation of the invention may be housed on the same computer as data parser 11, query agent 33 and structured data 15, or may be remote from data parser 11, query agent 33 and structured data 15.

Indeed, as discussed previously, a feature of the present invention is that different components of the present invention may be implemented independently and remote from each other, provided that some means of data communication between certain components is provided. FIGS. 4 and 5 provide diagrammatic examples of distributed implementations of the present invention and were discussed in detail previously.

B. WiFi and Cell Phones

Several embodiments of the present invention may be implemented through telephones, whether on wired or wireless networks. For example, the present invention may be implemented with a voice recognition component, and or voice generator, that allows the user to audibly communicate with the system. An audible query 60 would be converted into a digital text form, and processed as described previously. Such systems are for example useful in customer service models and the like. Audible responses 61 could for example be generated by storing sound clips in audio files associated with statements 20 of sentence tables 14. The matched statement 20 in sentence table 14 would then be used to access one or more audio files that would be played as response 61.

Text messaging represents another embodiment of the present invention that may be implemented through currently available telephonic devices such as cell and WiFi telephones, as well as in web browsers or as a stand-alone computer application. Interactions between text messaging implementations of the present invention may be between a single user and the present invention, multiple users and the present invention, between the present invention and one or more computer systems, or between the present invention and any combination of the above.

A simple single-user instant message interaction with the present invention is displayed in FIG. 10. In FIG. 10B, a user enters the query 60, “Does God exist?” The present invention provides as response 61 three answers each in the form of a sentence that directly addresses the question, a URL that identifies and links to the knowledge source providing the answer, and a prompt requesting user feedback as to the sufficiency of the answer provided. In the embodiment illustrated in FIG. 10, the present invention is accessed by adding an appropriate address to the user contact list, as depicted in FIG. 10A.

One of skill in the art will recognize that FIG. 10 is but one embodiment of the present invention, and that other variations are encompassed by the present claims. For example, answers provided in response 61 may contain additional components as described herein and as are obvious to one of skill in the art. Conversely, the number and form of response 61 will be to some degree be dictated by the implementation of the invention. For example, the illustration provided in FIG. 10 may be suitable for web browser and certain cell/WiFi telephone implementations that provide multi-line displays capable of displaying multi-answer responses 61, optionally including complex responses 61 containing both text and graphics. Other devices may only be capable of displaying single lines of text, or an audible response. In each instance, the device may be identified, for example by the query agent 33, and available information regarding the capabilities and/or limitations of the device communicated to the present invention. Identification of the device may be performed using any method available to one of skill in the art. For example, using pre-defined identifiers, or simply by having the present invention blindly return a device-readable response 61 that the device modifies to a format compatible with the display available to the device.

VI. Devices

Devices and systems for information storage and retrieval as described herein are also contemplated as being part of the present invention. Such devices and systems include stand-alone units, including hand-held units, wireless communication devices, and local and distributed information networks.

Stand-alone systems include workstations, including network workstations associated with separate data storage units as depicted in FIGS. 1A and B. Referring to FIG. 1A, the data parser 11, structured data 15, and query agent 33 may wholly or in part be included in workstation 34, data source 30, or in another suitable system. Alternatively, data parser 11, structured data 15, and query agent 33 may be implemented over an entire system, with each element of the present invention implemented as part of a different component of the system. Preferred stand-alone embodiments of the present invention include WiFi and cell phones, and systems where the data source, the data parser 11, structured data 15, query agent 33, and user interface are all housed in a single, preferably portable, ideally hand-held unit.

FIG. 9 is an illustration of one preferred embodiment of the present invention. The embodiment depicted in FIG. 9 is a portable USB device similar to well known memory sticks or pen drives. The device typically includes a protective casing 93 that may be less than two inches in length and ¼×½ of an inch wide. Alternative dimensions are also contemplated, e.g., lengths of less than 2, 4, 6 or 8 inches, with widths and heights selected independently from, for example, ¼, ½, ¾. 1, 1.5, 2, or 2.5 inches. The device has an interface adapter 92 suitable for connection to a communication device that preferably has a visual display or is capable of generating audible speech. In preferred embodiments, the interface adapter 92 also serves as a conduit for power necessary to operate the device. Within protective casing 93 are electronics for executing data parser 11 and query agent 33. These include a CPU 90 and memory 91. Means for allowing CPU 90 and memory 91 to communicate are well known in the art and include a common bus structure and the like. The electronics of the device may also include means for implementing structured data 15 and/or a data source for generating responses 61 to queries 60.

Particularly preferred devices are web-capable, ideally capable of using the World Wide Web as a data source.

All publications and patent applications cited in this specification are herein incorporated by reference as if each individual publication or patent application were specifically and individually indicated to be incorporated by reference.

Although the foregoing invention has been described in some detail by way of illustration and example for clarity and understanding, it will be readily apparent to one of ordinary skill in the art in light of the teachings of this invention that certain changes and modifications may be made thereto without departing from the spirit and scope of the appended claims.

What is claimed is:

1. A method for providing at least a best query response to a user, comprising:
a) receiving a query from the user;
b) processing the query by parsing the entire query wherein the word relationships of the entire query are used in ranking prospective query responses including identifying a best query response; and,
c) providing at least the best query response to the user.

2. The method of claim 1, wherein receiving the query comprises collecting keystrokes from a keyboard input.

3. The method of claim 1, wherein the query is in Natural Language format.

4. The method of claim 1, further comprising:
d) displaying an object indicating the accuracy of the query response in relation to the query from the user.

5. The method of claim 4, wherein the object in step d is a graphic image or a text message.

6. The method of claim 1, further comprising:
d) displaying a response indicating additional query responses are available for a fee;
e) providing a process for payment of the fee wherein payment of the fee executes a process for identifying the additional query responses and providing the additional query responses to the user.

7. The method of claim 1, wherein ranking prospective query responses comprises weighting prospective query response rank by comparing each prospective query response to user personal information wherein the rank of each prospective query response is adjusted in relation to the percentage match of the prospective query response to the user information.

8. The method of claim 1, wherein at least the best query response comprises:
a) at least one sentence; and,
b) a link to a source containing the at least one sentence.

9. The method of claim 8, wherein the at least one sentence is a plurality of sentences that are taken in context from the source.

10. The method of claim 1, wherein providing at least the best query response to the user comprises generating an analog signal, including at least the best query response, which is audible to the user.

11. The method of claim 10, wherein the analog signal is transmitted via a telephonic device.

12. The method of claim 1, wherein receiving the query comprises collecting a handwritten representation of the query and converting the handwritten representation to ASCII characters.

13. The method of claim 1, wherein receiving the query comprises collecting an audio input.

14. The method of claim 13, wherein the audio input is analog and processing comprises converting the audio input into a digital textual representation.

15. The method of claim 14, wherein the textual representation is ASCII characters.

16. The method of claim 13, wherein the audio input is digital.

17. The method of claim 13, wherein the audio input is from a telephonic device or network.

18. The method of claim 13, wherein the audio input is a streamed signal and the processing step comprises identifying the entire query in the streamed signal and parsing the entire query without interrupting receiving of the streamed signal.

19. The method of claim 18, wherein the audio input is analog and the processing step further comprises converting the identified entire enquiry into a digital representation.

20. The method of claim 1, further comprising providing the user with feedback solicitation.

21. The method of claim 1, further comprising determining a query context for the query.

22. The method of claim 21, wherein processing the query further comprises identifying a best query response by determining a response context for each prospective query response and comparing the query context to the response context for each prospective query response.

23. The method of claim 21, wherein the query context is to a geographic location.

24. The method of claim 21, wherein the query context is to a political or cultural issue.

25. The method of claim 21, wherein the query context is to an individual.

26. The method of claim 1, further comprising filtering the prospective query responses and assigning a relevancy tag to each prospective query response.

27. The method of claim 26, wherein assigning the relevancy tag includes displaying a relevancy explanation with each query response provided to the user.

28. The method of claim 1, wherein determining at least the best query response includes retaining a corresponding source ID for each prospective query response and rating each prospective query response based on a predetermined value ranking of the corresponding source ID.

29. The method of claim 1, wherein providing the user at least the best query response comprises sending the user at least the best query response through an instant messaging system.

30. The method of claim 1, wherein providing at least the best query response is performed by providing the user an audible analog speech message including at least the best query response.

31. A method for providing at least a best query response to a user, comprising:
a) receiving a query from the user;
b) processing the query through one or more query agents, each query agent comprising
i) a processing object for parsing the entire query wherein the word relationships of the entire query are used in ranking prospective query responses including identifying a best query response;
ii) a transmitting object for transmitting the parsed entire query to at least one domain; and,
iii) a receiving object for receiving at least the best query response from the at least one domain; and,
c) providing at least the best query response to the user.

32. The method of claim 31, wherein the at least one domain comprises one or more data stores selected from the group consisting of the world wide web, a local data store, a LAN data store, a WAN data store and the deep web.

33. A system for providing at least a best query response to a user, the system comprising:
a) a first user interface for receiving an entire query from the user;
b) a processing object for parsing the entire query wherein the word relationships of the entire query are used in ranking prospective query responses including identifying a best query response;
c) a second user interface for presenting at least the best query response to the user.

34. The system of claim 33, wherein the first user interface is the same as the second user interface.

35. The system of claim 34, wherein the first user interface is a web browser executed on a computer.

36. The system of claim 33, wherein the first user interface is a telephonic transmitter and the second user interface is a telephonic receiver.

37. The system of claim 33, wherein the first user interface is an electronic graphical tablet.

38. The system of claim 33, further comprising one or more query agents and the processing object further comprising a communication object for transmitting the parsed entire query to at least one query agent and receiving at least the best query response from at least one query agent.

39. The system of claim 33, further comprising one or more query agents and the processing object further comprising a communication object for transmitting the parsed entire query to at least one query agent and receiving at least the best query response from at least one query agent.

40. The system of claim 39, wherein each query agent is independently associated with one or more data stores.

41. The system of claim 39, wherein the communication object includes one or more communication links to at least one query agent wherein the communication links are selected from the group consisting of TCP/IP, NETBEUI, telephonic, SMS and RSS.

42. The system of claim 41, wherein the one or more communication links is wireless.

43. A method for providing at least a best advertisement response to a user, comprising:
a) receiving a query from the user;
b) processing the query whereby a query statement is created by parsing the entire query, the query statement thereby encoding word relationships of the entire query;
c) ranking a set of prospective advertisement responses, including identifying a best advertisement response, using the query statement; and,
d) providing at least the best advertisement response to the user.

44. A method of operating an information provision business comprising:
a) receiving a query from the user;
b) processing the query by parsing the entire query wherein the word relationships of the entire query are used in ranking prospective query responses including identifying a best query response;
c) providing at least the best query response to the user;
d) comparing at least the best query response to a predetermined set of advertisement responses wherein at least a best advertisement response is identified; and
e) providing at least the best advertisement response to the user.

45. A method of efficiently storing information in an encoded database, comprising:
a) retrieving a document;
b) processing the document by:
i) extracting one or more sentences from the document;
ii) parsing each sentence into one or more wordsets wherein
(a) each wordset includes a plurality of words;
(b) words within each wordset are contextually related and spatially orientated in the same order within the wordset as in the sentence; and,
(c) all words in the sentence are a member of at least one wordset; and,
iii) linking all wordsets parsed from the sentence to form a statement wherein the linked wordsets are spatially related to each other in the statement according to the position in the sentence of the respective first word of each wordset;
c) constructing a data set of statements representing the document; and,
d) storing the data set in a database.
